(19) United States
(12) Patent Application Publication
(10) Pub. No.: US 2026/0051274 A1
(43) Pub. Date: Feb. 19, 2026

(54) DISPLAY CELL AND TEST SYSTEM INCLUDING THE SAME

(71) Applicant: Samsung Display Co., LTD., Yongin-si (KR)

(72) Inventors: SOOJO OCK, Yongin-si (KR); HYUNGJIN SONG, Yongin-si (KR); CHAEHAN HYUN, Yongin-si (KR); Jiwon Yeo, Yongin-si (KR); KWANGSAE LEE, Yongin-si (KR); CHANGWON JEONG, Yongin-si (KR); SEUNG-YEON CHO, Yongin-si (KR)

(21) Appl. No.: 19/207,717

(22) Filed: May 14, 2025

(30) Foreign Application Priority Data
Aug. 16, 2024 (KR) 10-2024-0109690

(51) Int. Cl. G09G 3/00

(52) U.S. Cl. CPC G09G 3/006; G09G 2310/08; G09G 2320/028; G09G 2330/12

(57) ABSTRACT

A display cell includes a display area including a normal pixel which includes first to fourth normal sub-pixels and has a normal viewing angle, and a private pixel which includes first to fourth private sub-pixels and has a private viewing angle different from the normal viewing angle, and an test circuit configured to test a private mode in which only the private pixel is illuminated by providing a light-off voltage and a light-on voltage to the normal pixel and the private pixel. The test circuit provides the light-on voltage to at least one of the first to fourth private sub-pixels independently from the first to fourth normal sub-pixels.

This application claims priority to Korean Patent Application No. 10-2024-0109690, filed on Aug. 16, 2024, and all the benefits accruing therefrom under 35 U.S.C. § 119, the content of which in its entirety is herein incorporated by reference.

### BACKGROUND

### 1. Field

Embodiments of the inventive concept relates to a display cell and a test system including the same. More particularly, the inventive concept relates to a display cell and a test system including the same for performing a private mode test.

### 2. Description of the Related Art

A display cell refers to a state in which a display substrate produced through a fabrication (“FAB”) manufacturing process (e.g., a thin-film transistor (“TFT”) process, an evaporation process, and an encapsulation process) is cut to an appropriate size according to a purpose of a final product.

A test device may provide a signal and a voltage to the display cell to perform a cell test on the display cell. The cell test refers to a test performed before the display cell is mounted on a display device as a display panel. The cell test may include an array test which tests an electrical defect of the display cell and a light-on test which tests a light-on defect.

For example, the light-on test may include a private mode test. The display cell may include a normal pixel and a private pixel. The private mode refers to a mode in which only the private pixel lights up.

### SUMMARY

Embodiments of the inventive concept provide a display cell for performing a private mode test.

Embodiments of the inventive concept provide a test system including the display cell.

In an embodiment of a display cell according to the inventive concept, the display cell includes a display area including a normal pixel which includes a first normal sub-pixel to a fourth normal sub-pixel and has a normal viewing angle, and a private pixel which includes a first private sub-pixel to a fourth private sub-pixel and has a private viewing angle different from the normal viewing angle, and an test circuit configured to test a private mode in which only the private pixel is illuminated by providing a light-off voltage and a light-on voltage to the normal pixel and the private pixel. The test circuit provides the light-on voltage to at least one of the first normal sub-pixel to the fourth private sub-pixel independently from the first private sub-pixel to the fourth normal sub-pixel.

In an embodiment, the private viewing angle may be less than the normal viewing angle.

In an embodiment, the first normal sub-pixel and the second normal sub-pixel may be connected to a first data line, the third normal sub-pixel and the first private sub-pixel may be connected to a second data line, the second private sub-pixel and the third private sub-pixel may be connected to a third data line, and the fourth normal sub-pixel and the fourth private sub-pixel may be connected to a fourth data line.

In an embodiment, the first normal sub-pixel and the third private sub-pixel may display a blue, the second normal sub-pixel and the second private sub-pixel may display a red, and the third normal sub-pixel, the first private sub-pixel, the fourth normal sub-pixel, and the fourth private sub-pixel may display a green.

In an embodiment, the first normal sub-pixel, the third normal sub-pixel, the second private sub-pixel, and the fourth normal sub-pixel may receive the light-off voltage and the light-on voltage in response to a first gate signal, and the second normal sub-pixel, the first private sub-pixel, the third private sub-pixel, and the fourth private sub-pixel may receive the light-off voltage and the light-on voltage in response to a second gate signal.

In an embodiment, the test circuit may include a first transistor including a gate electrode receiving a light-off signal, a first electrode receiving a first light-off voltage, and a second electrode connected to the first data line, a second transistor including a gate electrode receiving a red light-on signal, a first electrode receiving a red voltage, and a second electrode connected to the first data line, a third transistor including a gate electrode receiving a blue light-on signal, a first electrode receiving a blue voltage, and a second electrode connected to the first data line, a fourth transistor including a gate electrode receiving the light-off signal, a first electrode receiving the first light-off voltage, and a second electrode connected to the second data line, a fifth transistor including a gate electrode receiving a green light-on signal, a first electrode receiving a green voltage, and a second electrode connected to the second data line, a sixth transistor including a gate electrode receiving the light-off signal, a first electrode receiving a second light-off voltage, and a second electrode connected to the third data line, a seventh transistor including a gate electrode receiving a private red light-on signal, a first electrode receiving the red voltage, and a second electrode connected to the third data line, an eighth transistor including a gate electrode receiving a private blue light-on signal, a first electrode receiving the blue voltage, and a second electrode connected to the third data line, a ninth transistor including a gate electrode receiving the light-off signal, a first electrode receiving the second light-off voltage, and a second electrode connected to the fourth data line, and a tenth transistor including a gate electrode receiving the green light-on signal, a first electrode receiving the green voltage, and a second electrode connected to the fourth data line.

In an embodiment, in a first sub-duration, each of the first gate signal and the light-off signal may have an activation pulse, in a second sub-duration, each of the first gate signal and the private red light-on signal may have the activation pulse, in a third sub-duration, each of the second gate signal and the light-off signal may have the activation pulse, and in a fourth sub-interval, each of the second gate signal, the private blue light-on signal, and the green light-on signal may have the activation pulse.

In an embodiment, the test circuit may include a first transistor including a gate electrode receiving a private red light-on signal, a first electrode receiving a first light-off voltage, and a second electrode connected to the first data line, a second transistor including a gate electrode receiving a private blue light-on signal, a first electrode receiving the first light-off voltage, and a second electrode connected to the first data line, a third transistor including a gate electrode receiving a red light-on signal, a first electrode receiving a red voltage, and a second electrode connected to the first data line, a fourth transistor including a gate electrode receiving a blue light-on signal, a first electrode receiving a blue voltage, and a second electrode connected to the first data line, a fifth transistor including a gate electrode receiving the private red light-on signal, a first electrode receiving the first light-off voltage, and a second electrode connected to the second data line, a sixth transistor including a gate electrode receiving a green light-on signal, a first electrode receiving a green voltage, and a second electrode connected to the second data line, a seventh transistor including a gate electrode receiving the private red light-on signal, a first electrode receiving the red voltage, and a second electrode connected to the third data line, an eighth transistor including a gate electrode receiving the private blue light-on signal, a first electrode receiving the blue voltage, and a second electrode connected to the third data line, a ninth transistor including a gate electrode receiving the red light-on signal, a first electrode receiving the blue voltage, and a second electrode connected to the third data line, a tenth transistor including a gate electrode receiving the blue light-on signal, a first electrode receiving the red voltage, and a second electrode connected to the third data line, an eleventh transistor including a gate electrode receiving the private red light-on signal, a first electrode receiving the first light-off voltage, and a second electrode connected to the fourth data line, and a twelfth transistor including a gate electrode receiving the green light-on signal, a first electrode receiving the green voltage, and a second electrode connected to the fourth data line.

In an embodiment, in a first sub-duration, the first gate signal may have an activation pulse, in a second sub-duration, each of the first gate signal and the private red light-on signal may have the activation pulse, in a third sub-duration, the second gate signal may have the activation pulse, and in a fourth sub-duration, each of the second gate signal, the private blue light-on signal, and the green light-on signal may have the activation pulse.

In an embodiment, the first normal sub-pixel and the second normal sub-pixel may be connected to a first data line, the third normal sub-pixel and the fourth normal sub-pixel may be connected to a second data line, the second private sub-pixel and the third private sub-pixel may be connected to a third data line, and the first private sub-pixel and the fourth private sub-pixel may be connected to a fourth data line.

In an embodiment, the first normal sub-pixel and the third private sub-pixel may display a blue, the second normal sub-pixel and the second private sub-pixel may display a red, and the third normal sub-pixel, the first private sub-pixel, the fourth normal sub-pixel, and the fourth private sub-pixel may display a green.

In an embodiment, the first normal sub-pixel, the third normal sub-pixel, the second private sub-pixel, and the fourth normal sub-pixel may receive the light-off voltage and the light-on voltage in response to a first gate signal, and the second normal sub-pixel, the first private sub-pixel, the third private sub-pixel, and the fourth private sub-pixel may receive the light-off voltage and the light-on voltage in response to a second gate signal.

In an embodiment, the test circuit may include a first transistor including a gate electrode receiving a light-off signal, a first electrode receiving a first light-off voltage, and a second electrode connected to the first data line, a second transistor including a gate electrode receiving a red light-on signal, a first electrode receiving a red voltage, and a second electrode connected to the first data line, a third transistor including a gate electrode receiving a blue light-on signal, a first electrode receiving a blue voltage, and a second electrode connected to the first data line, a fourth transistor including a gate electrode receiving the light-off signal, a first electrode receiving the first light-off voltage, and a second electrode connected to the second data line, a fifth transistor including a gate electrode receiving a green light-on signal, a first electrode receiving a green voltage, and a second electrode connected to the second data line, a sixth transistor including a gate electrode receiving the light-off signal, a first electrode receiving a second light-off voltage, and a second electrode connected to the third data line, a seventh transistor including a gate electrode receiving a private red light-on signal, a first electrode receiving the red voltage, and a second electrode connected to the third data line, an eighth transistor including a gate electrode receiving a private blue light-on signal, a first electrode receiving the blue voltage, and a second electrode connected to the third data line, a ninth transistor including a gate electrode receiving the light-off signal, a first electrode receiving the second light-off voltage, and a second electrode connected to the fourth data line, and a tenth transistor including a gate electrode receiving a private green light-on signal, a first electrode receiving the green voltage, and a second electrode connected to the fourth data line.

In an embodiment, in a first sub-duration, each of the first gate signal and the light-off signal may have an activation pulse, in a second sub-duration, each of the first gate signal and the private red light-on signal may have the activation pulse, in a third sub-duration, each of the second gate signal and the light-off signal may have the activation pulse, and in a fourth sub-duration, each of the second gate signal and the private blue light-on signal may have the activation pulse.

In an embodiment, the first normal sub-pixel and the third private sub-pixel may be connected to a first data line, the third normal sub-pixel and the first private sub-pixel may be connected to a second data line, the second normal sub-pixel and the second private sub-pixel may be connected to a third data line, and the fourth normal sub-pixel and the fourth private sub-pixel may be connected to a fourth data line.

In an embodiment, the first normal sub-pixel and the third private sub-pixel may display a blue, the second normal sub-pixel and the second private sub-pixel may display a red, and the third normal sub-pixel, the first private sub-pixel, the fourth normal sub-pixel, and the fourth private sub-pixel may display a green.

In an embodiment, the first normal sub-pixel, the third normal sub-pixel, the second private sub-pixel, and the fourth normal sub-pixel may receive the light-off voltage and the light-on voltage in response to a first gate signal, and the second normal sub-pixel, the first private sub-pixel, the third private sub-pixel, and the fourth private sub-pixel may receive the light-off voltage and the light-on voltage in response to a second gate signal.

In an embodiment, the test circuit may include a first transistor including a gate electrode receiving a light-off signal, a first electrode receiving a first light-off voltage, and a second electrode connected to the first data line, a second transistor including a gate electrode receiving a green-blue light-on signal, a first electrode receiving a blue voltage, and a second electrode connected to the first data line, a third transistor including a gate electrode receiving the light-off signal, a first electrode receiving the first light-off voltage, and a second electrode connected to the second data line, a fourth transistor including a gate electrode receiving the green-blue light-on signal, a first electrode receiving a green voltage, and a second electrode connected to the second data line, a fifth transistor including a gate electrode receiving the light-off signal, a first electrode receiving a second light-off voltage, and a second electrode connected to the third data line, a sixth transistor including a gate electrode receiving a red light-on signal, a first electrode receiving a red voltage, and a second electrode connected to the third data line, a seventh transistor including a gate electrode receiving the light-off signal, a first electrode receiving the second light-off voltage, and a second electrode connected to the fourth data line, and an eighth transistor including a gate electrode receiving the green-blue light-on signal, a first electrode receiving the green voltage, and a second electrode connected to the fourth data line.

In an embodiment, in a first sub-duration, each of the first gate signal and the light-off signal may have an activation pulse, in a second sub-duration, each of the first gate signal and the red light-on signal may have the activation pulse, in a third sub-duration, each of the second gate signal and the light-off signal may have the activation pulse, and in a fourth sub-duration, each of the second gate signal and the green-blue light-on signals may have the activation pulse.

In an embodiment of a test system according to the inventive concept, the test system includes a display cell including a display area and a test circuit connected to the display area, and a test device configured to provide a signal and a voltage to the display cell. the display area including a normal pixel which includes a first normal sub-pixel to a fourth normal sub-pixel and has a normal viewing angle, and a private pixel which includes a first private sub-pixel to a fourth private sub-pixel and has a private viewing angle different from the normal viewing angle. A test circuit tests a private mode in which only the private pixel is illuminated by providing a light-off voltage and a light-on voltage to the normal pixel and the private pixel. The test circuit provides the light-on voltage to at least one of the first private sub-pixel to the fourth private sub-pixel independently from the first normal sub-pixel to the fourth normal sub-pixel.

According to the display cell and the test system, the test circuit may provide the light-on voltage to at least one of the first to fourth private sub-pixels independently from the first to fourth normal sub-pixels. Accordingly, whether the private mode is operating normally may be tested.

### BRIEF DESCRIPTION OF THE DRAWINGS

The above and other features of embodiments of the inventive concept will become more apparent by describing in detailed embodiments thereof with reference to the accompanying drawings, in which:

FIG. 1 is a block diagram showing a display device according to the inventive concept;

FIG. 2 is a circuit diagram showing an embodiment of a pixel of FIG. 1;

FIG. 3 is a diagram showing an embodiment of a structure of a pixel of FIG. 1;

FIG. 4 is a block diagram showing a test system;

FIG. 5A is a circuit diagram showing a conventional display cell;

FIG. 5B is a timing diagram showing a signal applied to a conventional display cell of FIG. 5B;

FIG. 5C is a circuit diagram showing an operation of a conventional display cell of FIG. 5A in a first sub-duration of FIG. 5B;

FIG. 5D is a circuit diagram showing an operation of a conventional display cell of FIG. 5A in a second sub-duration of FIG. 5B;

FIG. 5E is a circuit diagram showing an operation of a conventional display cell of FIG. 5A in a third sub-duration of FIG. 5B;

FIG. 6A is a circuit diagram showing an embodiment of a display cell according to the inventive concept;

FIG. 6B is a timing diagram showing an embodiment of a signal applied to a display cell in an embodiment of the inventive concept of FIG. 6A;

FIG. 6C is a circuit diagram showing an embodiment of an operation of a display cell in an embodiment of the inventive concept of FIG. 6A in a first sub-duration of FIG. 6B;

FIG. 6D is a circuit diagram showing an embodiment of an operation of a display cell in an embodiment of the inventive concept of FIG. 6A in a second sub-duration of FIG. 6B;

FIG. 6E is a circuit diagram showing an embodiment of an operation of a display cell in an embodiment of the inventive concept of FIG. 6A in a third sub-duration of FIG. 6B;

FIG. 6F is a circuit diagram showing an embodiment of an operation of a display cell in an embodiment of the inventive concept of FIG. 6A in a fourth sub-duration of FIG. 6B;

FIG. 7A is a circuit diagram showing an embodiment of a display cell according to the inventive concept;

FIG. 7B is a timing diagram showing an embodiment of a signal applied to a display cell in an embodiment of the inventive concept of FIG. 7A;

FIG. 8A is a circuit diagram showing an embodiment of a display cell according to the inventive concept;

FIG. 8B is a timing diagram showing an embodiment of a signal applied to a display cell in an embodiment of the inventive concept of FIG. 8A;

FIG. 9A is a circuit diagram showing an embodiment of a display cell according to the inventive concept;

FIG. 9B is a timing diagram showing a signal applied to a display cell in an embodiment of the disclosure of FIG. 9A;

FIG. 10A is a circuit diagram showing an embodiment of a display cell according to the inventive concept;

FIG. 10B is a timing diagram showing an embodiment of a signal applied to a display cell in an embodiment of the inventive concept of FIG. 10A;

FIG. 11A is a circuit diagram showing an embodiment of a display cell according to the inventive concept;

FIG. 11B is a timing diagram showing an embodiment of a signal applied to a display cell in an embodiment of the inventive concept of FIG. 11A;

FIG. 12 is a block diagram showing an electronic device; and

FIG. 13 is a diagram showing an embodiment in which an electronic device of FIG. 12 is implemented as a smart phone.

### DETAILED DESCRIPTION

Hereinafter, the inventive concept will be described in more detail with reference to the accompanying drawings.

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it may be directly on the other element or intervening elements may be present therebetween. In contrast, when an element is referred to as being “directly on”another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or. ” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” may therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” may, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

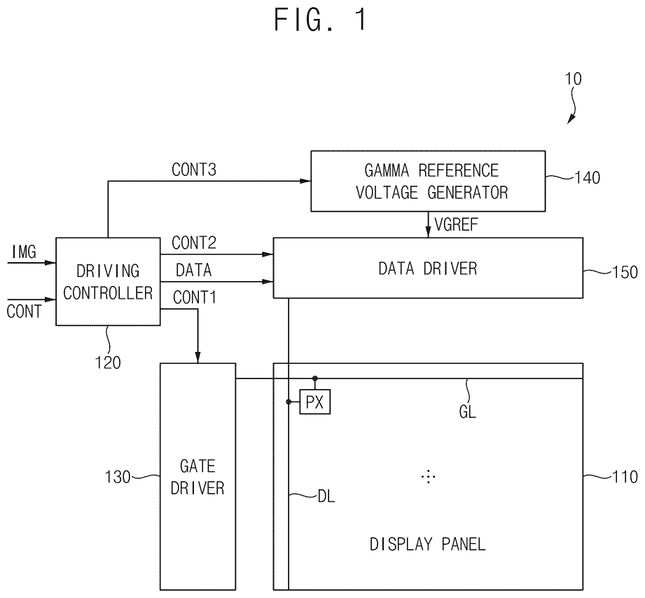

FIG. 1 is a block diagram showing an embodiment of a display device 10 according to the inventive concept.

Referring to FIG. 1, a display device 10 may include a display panel 110 and a display panel driver. The display panel driver may include a driving controller 120, a gate driver 130, a gamma reference voltage generator 140, and a data driver 150.

The display panel 110 may include a display area for displaying an image and a peripheral area disposed next (adjacent) to the display area.

The display panel 110 may include pixels PX connected to gate lines GL, data lines DL, and pixels PX electrically connected to each of the gate lines GL and the data lines DL. The gate lines GL may extend in a first direction, and the data lines DL may extend in a second direction intersecting the first direction.

The driving controller 120 may receive input image data IMG and an input control signal CONT from an external device (not shown). In an embodiment, the input image data IMG may include red image data, green image data, and blue image data, for example. The input image data IMG may include white image data. The input image data IMG may include magenta image data, yellow image data, and cyan image data. The input control signal CONT may include a master clock signal and a data enable signal. The input control signal CONT may further include a vertical synchronization signal and a horizontal synchronization signal.

The driving controller 120 may generate a first control signal CONT1, a second control signal CONT2, a third control signal CONT3, and a data signal DATA based on the input image data IMG and the input control signal CONT.

The driving controller 120 may generate the first control signal CONT1 for controlling an operation of the gate driver 130 based on the input control signal CONT, and output the first control signal CONT1 to the gate driver 130. The first control signal CONT1 may include a vertical start signal and a gate clock signal.

The driving controller 120 may generate the second control signal CONT2 for controlling an operation of the data driver 150 based on the input control signal CONT, and output the second control signal CONT2 to the data driver 150. The second control signal CONT2 may include a horizontal start signal and a load signal.

The driving controller 120 may generate the data signal DATA based on the input image data IMG. The driving controller 120 may output the data signal DATA to the data driver 150.

The driving controller 120 may generate the third control signal CONT3 for controlling an operation of the gamma reference voltage generator 140 based on the input control signal CONT, and output the third control signal CONT3 to the gamma reference voltage generator 140.

The gate driver 130 may generate gate signals for driving the gate lines GL in response to the first control signal CONT1 received from the driving controller 120. The gate driver 130 may sequentially output the gate signals to the gate lines GL in units of rows.

The gamma reference voltage generator 140 may generate a gamma reference voltage VGREF based on the third control signal CONT3 received from the driving controller 120. The gamma reference voltage generator 140 may provide the gamma reference voltage VGREF to the data driver 150. The gamma reference voltage VGREF may have a value corresponding to each data signal DATA.

In an embodiment, the gamma reference voltage generator 140 may be disposed within the driving controller 120 or within the data driver 150, for example.

The data driver 150 may receive the second control signal CONT2 and the data signal DATA from the driving controller 120, and convert the data signal DATA into a data voltage having an analog type. The data driver 150 may output the data voltage to the data line DL.

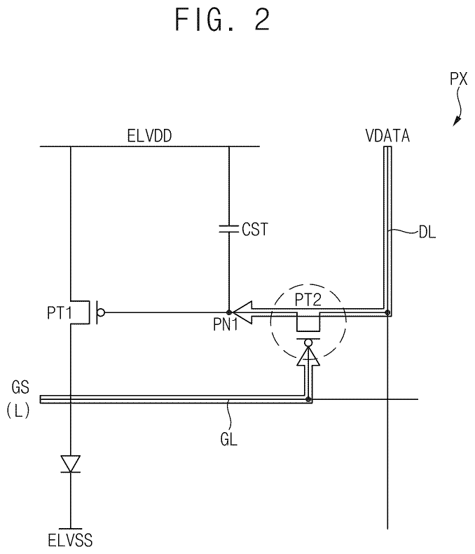

FIG. 2 is a circuit diagram showing an embodiment of a pixel PX of FIG. 1.

Referring to FIG. 1 and FIG. 2, a display panel 110 may include pixels PX. Each of the pixels PX may include a first pixel transistor PT1, a second pixel transistor PT2, a storage capacitor CST, and a light-emitting element EL. In an embodiment, the first pixel transistor PT1 and the second pixel transistor PT2 may be p-type metal oxide semiconductor (“PMOS”) transistors.

The first pixel transistor PT1 may include a gate electrode connected to a first pixel node PN1, a first electrode receiving a first power supply voltage ELVDD, and a second electrode. The first pixel transistor PT1 may generate a driving current in response to a voltage of the first pixel node PN1.

The second pixel transistor PT2 may include a gate electrode connected to a gate line GL transmitting a gate signal GS, a first electrode connected to a data line DL transmitting a data voltage VDATA, and a second electrode connected to the first pixel node PN1. The second pixel transistor PT2 may be turned on in response to a gate signal GS having a relatively low level L to provide the data voltage VDATA to the first pixel node PN1.

The storage capacitor CST may include a first electrode receiving the first power supply voltage ELVDD and a second electrode connected to the first pixel node PN1. The storage capacitor CST may store the data voltage VDATA.

The light-emitting element EL may include an anode connected to the second electrode of the first pixel transistor PT1 and a cathode receiving a second power supply voltage ELVSS. The light-emitting element EL may emit a light based on the driving current.

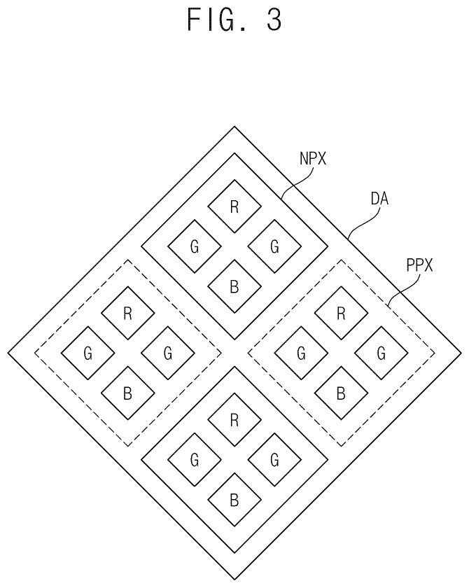

FIG. 3 is a diagram showing an embodiment of a structure of a pixel PX of FIG. 1.

Referring to FIGS. 1 to 3, a display panel 110 may include a display area DA which displays an image, and the display area DA may include pixels PX. Each of the pixels PX may be a normal pixel NPX or a private pixel PPX. A normal viewing angle, which is a viewing angle of an image displayed by the normal pixel NPX, may be different from a private viewing angle, which is a viewing angle of an image displayed by the private pixel PPX. The private viewing angle may be less than the normal viewing angle. Specifically, unlike the normal pixel NPX, the private pixel PPX may have a light-blocking film disposed on the light-emitting element EL. The light-blocking film may block a portion of the light emitted from the light-emitting element EL. Therefore, the private pixel PPX may implement a narrow viewing angle using the light-blocking film. Therefore, when the normal pixel NPX and the private pixel PPX light on together, a viewing angle of the image displayed on the display area DA may be as relatively large as the normal viewing angle, and a display device 10 may operate in a normal mode. When only the private pixel PPX lights on, the viewing angle of the image displayed on the display area DA may be as relatively small as the private viewing angle, and the display device 10 may operate in a private mode.

The display area DA may have a diamond pentile structure. In an embodiment, the normal pixel NPX may include four normal sub-pixels, and the private pixel PPX may include four private sub-pixels, for example. In an embodiment, among the four normal sub-pixels, one normal sub-pixel may display a red R, one normal sub-pixel may display a blue B, and two normal sub-pixels may display a green G, for example. In an embodiment, among the four private sub-pixels, one private sub-pixel may display the red R, one private sub-pixel may display the blue B, and two private sub-pixels may display the green G, for example.

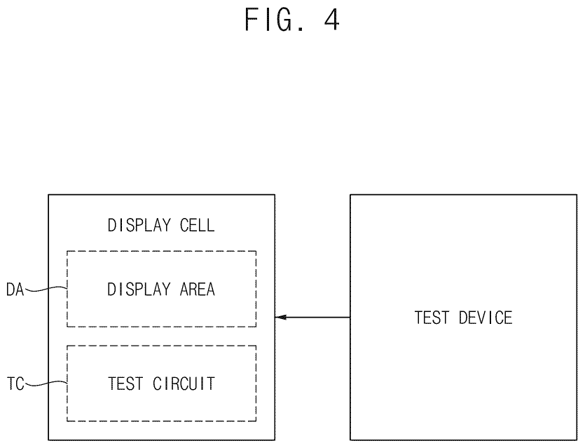

FIG. 4 is a block diagram showing a test system.

Referring to FIGS. 1 to 4, a test system may include a display cell and a test device which tests the display cell. The display cell refers to a state generated through a fabrication (“FAB”) manufacturing process before being disposed (e.g., mounted) on a display device 10 as a display panel 110.

The display cell may include a display area DA which displays an image and a test circuit TC connected to the display area DA.

The test device may generate a signal and a voltage to provide the signal and the voltage to the display cell. The signal and the voltage may be directly applied to the display area DA or indirectly applied to the display area DA through the test circuit TC. In an embodiment, the test circuit TC may provide a light-off voltage and a light-on voltage to the display area DA, for example.

The signal and the voltage indirectly applied to the display area DA through the test circuit TC may vary according to a structure of the display area DA and a structure of the test circuit TC. Therefore, in order for the test system to test whether the private mode operates normally, the structure of the test circuit TC according to the structure of the display area DA may be important.

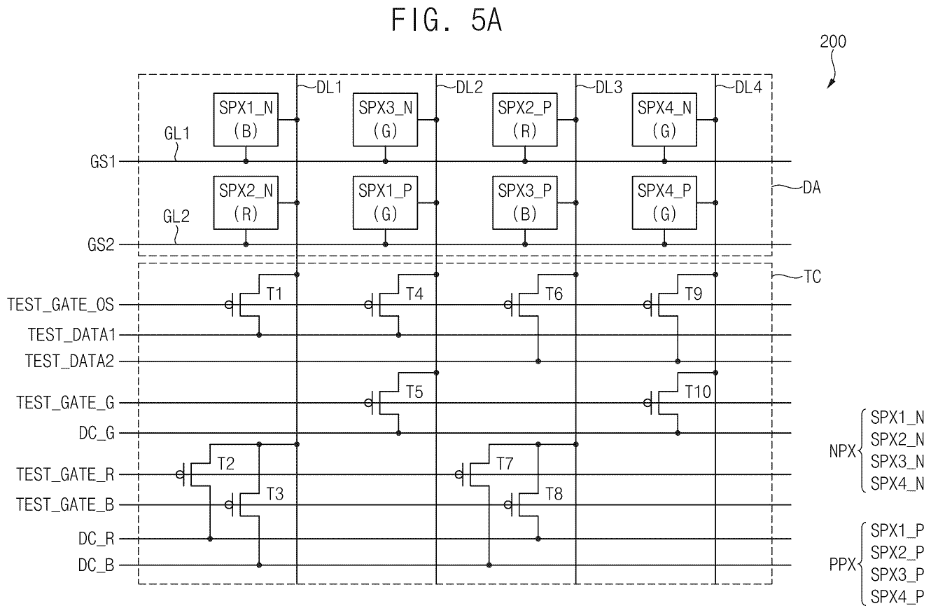

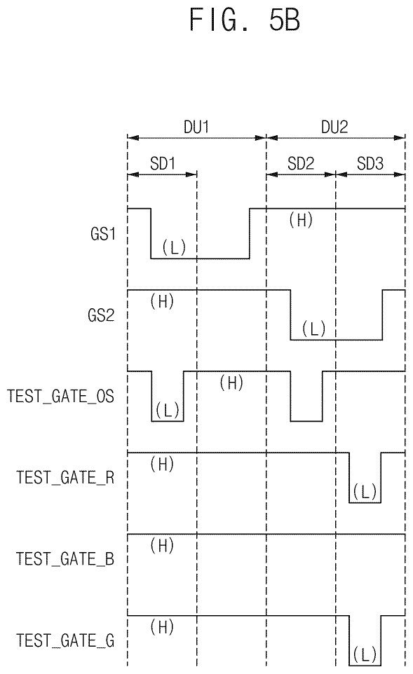

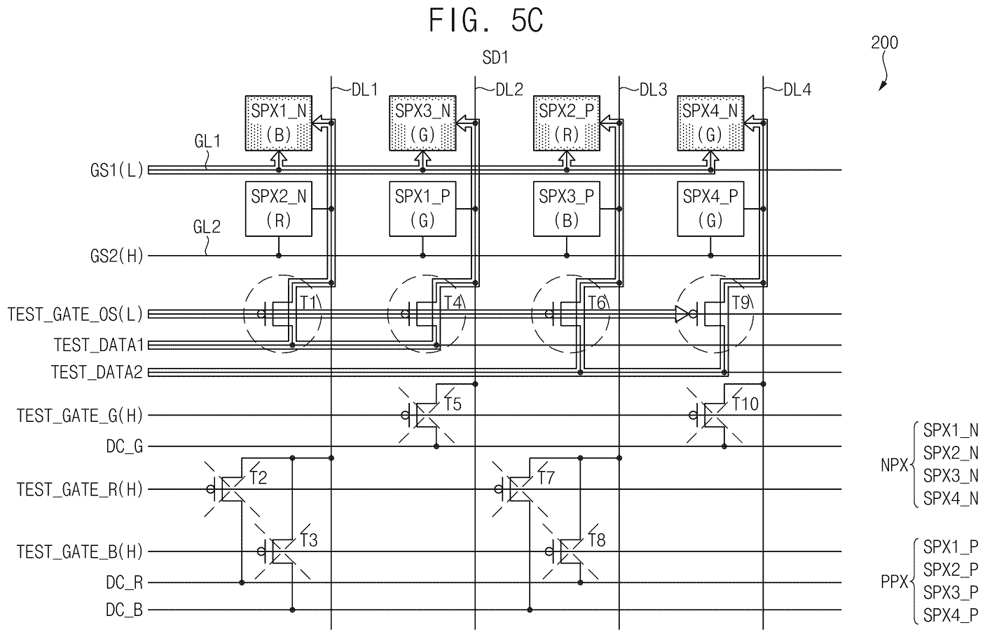

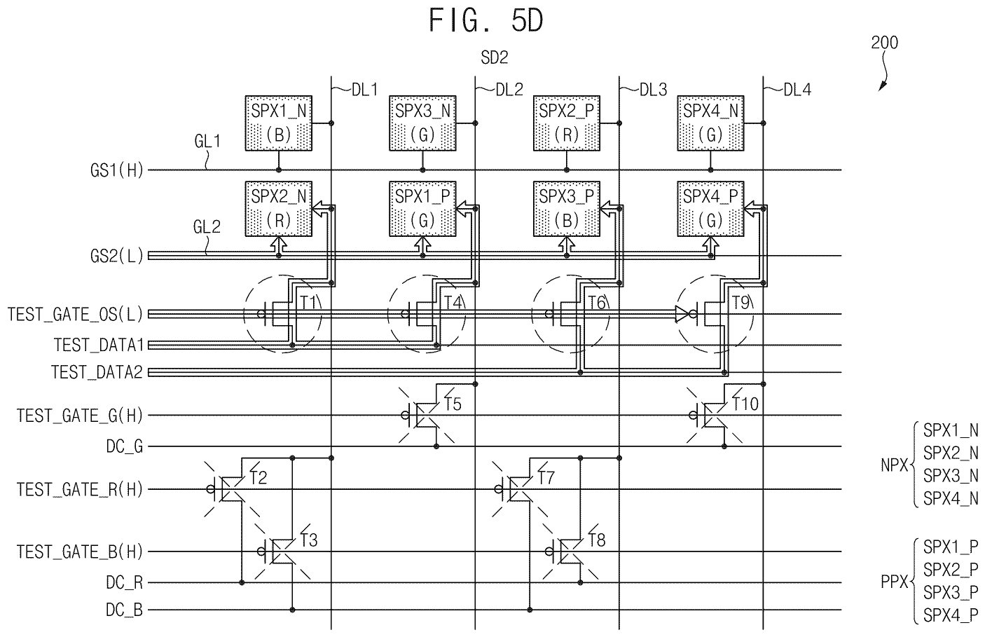

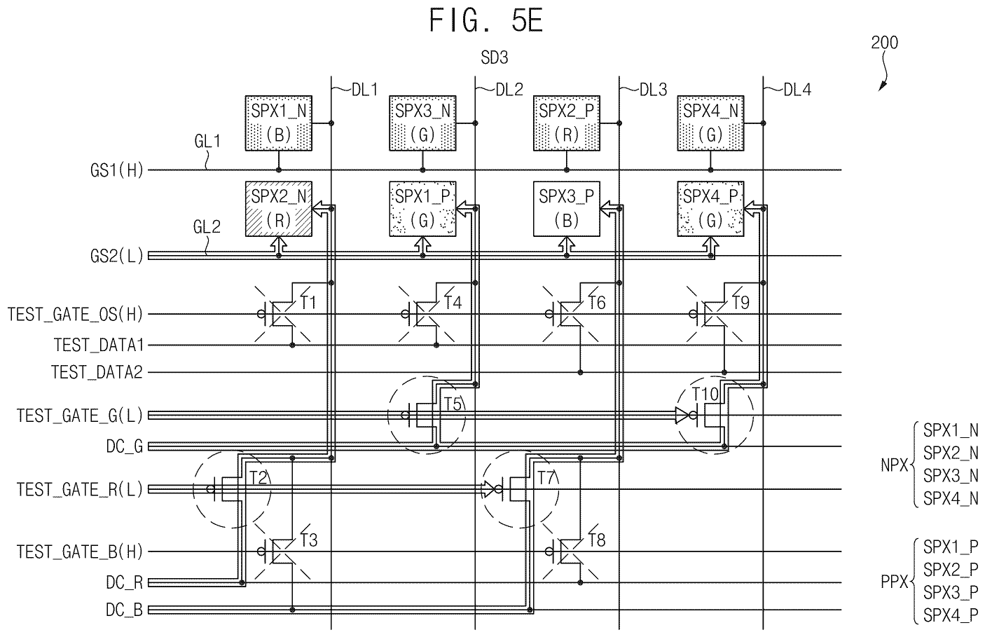

FIG. 5A is a circuit diagram showing a conventional display cell 200. FIG. 5B is a timing diagram showing a signal applied to a conventional display cell 200 of FIG. 5B. FIG. 5C is a circuit diagram showing an operation of a conventional display cell 200 of FIG. 5A in a first sub-duration SD1 of FIG. 5B. FIG. 5D is a circuit diagram showing an operation of a conventional display cell 200 of FIG. 5A in a second sub-duration SD2 of FIG. 5B. FIG. 5E is a circuit diagram showing an operation of a conventional display cell 200 of FIG. 5A in a third sub-duration SD3 of FIG. 5B.

Referring to FIG. 5A, a conventional display cell 200 may include a display area DA and a test circuit TC.

The display area DA may include a normal pixel NPX and a private pixel PPX. The normal pixel NPX may include first to fourth normal sub-pixels SPX1_N to SPX4_N. The private pixel PPX may include first to fourth private sub-pixels SPX1_P to SPX4_P. In an embodiment, the first normal sub-pixel SPX1_N and the third private sub-pixel SPX3_P may display a blue B. The second normal sub-pixel SPX2_N and the second private sub-pixel SPX2_P may display a red R. The third normal sub-pixel SPX3_N, the first private sub-pixel SPX1_P, the fourth normal sub-pixel SPX4_N, and the fourth private sub-pixel SPX4_P may display a green G.

The first normal sub-pixel SPX1_N and the second normal sub-pixel SPX2_N may be connected to a first data line DL1. The third normal sub-pixel SPX3_N and the first private sub-pixel SPX1_P may be connected to a second data line DL2. The second private sub-pixel SPX2_P and the third private sub-pixel SPX3_P may be connected to a third data line DL3. The fourth normal sub-pixel SPX4_N and the fourth private sub-pixel SPX4_P may be connected to a fourth data line DL4.

The first normal sub-pixel SPX1_N, the third normal sub-pixel SPX3_N, the second private sub-pixel SPX2_P, and the fourth normal sub-pixel SPX4_N may be connected to a first gate line GL1 transmitting a first gate signal GS1. The second normal sub-pixel SPX2_N, the first private sub-pixel SPX1_P, the third private sub-pixel SPX3_P, and the fourth private sub-pixel SPX4_P may be connected to a second gate line GL2 transmitting a second gate signal GS2.

The test circuit TC may include first to tenth transistors T1 to T10. In an embodiment, the first to tenth transistors T1 to T10 may be PMOS transistors.

The first transistor T1 may include a gate electrode receiving a light-off signal TEST_GATE_OS, a first electrode receiving a first light-off voltage TEST_DATA1, and a second electrode connected to the first data line DL1.

The second transistor T2 may include a gate electrode receiving a red light-on signal TEST_GATE_R, a first electrode receiving a red voltage DC_R, and a second electrode connected to the first data line DL1.

The third transistor T3 may include a gate electrode receiving a blue light-on signal TEST_GATE_B, a first electrode receiving a blue voltage DC_B, and a second electrode connected to the first data line DL1.

The fourth transistor T4 may include a gate electrode receiving the light-off signal TEST_GATE_OS, a first electrode receiving the first light-off voltage TEST_DATA1, and a second electrode connected to the second data line DL2.

The fifth transistor T5 may include a gate electrode receiving a green light-on signal TEST_GATE_G, a first electrode receiving a green voltage DC_G, and a second electrode connected to the second data line DL2.

The sixth transistor T6 may include a gate electrode receiving the light-off signal TEST_GATE_OS, a first electrode receiving a second light-off voltage TEST_DATA2, and a second electrode connected to the third data line DL3.

The seventh transistor T7 may include a gate electrode receiving the red light-on signal TEST_GATE_R, a first electrode receiving the blue voltage DC_B, and a second electrode connected to the third data line DL3.

The eighth transistor T8 may include a gate electrode receiving the blue light-on signal TEST_GATE_B, a first electrode receiving the red voltage DC_R, and a second electrode connected to the third data line DL3.

The ninth transistor T9 may include a gate electrode receiving the light-off signal TEST_GATE_OS, a first electrode receiving the second light-off voltage TEST_DATA2, and a second electrode connected to the fourth data line DL4.

The tenth transistor T10 may include a gate electrode receiving the green light-on signal TEST_GATE_G, a first electrode receiving the green voltage DC_G, and a second electrode connected to the fourth data line DL4.

Here, the first light-off voltage TEST_DATA1 and the second light-off voltage TEST_DATA2 may be voltages which light off the first to fourth normal sub-pixels SPX1_N to SPX4_N and the first to fourth private sub-pixels SPX1_P to SPX4_P. The red voltage DC_R may be a voltage which lights on sub-pixels SPX2_N, SPX2_P displaying the red R. The blue voltage DC_B may be a voltage which lights on sub-pixels SPX1_N, SPX3_P displaying the blue B. The green voltage DC_G may be a voltage which lights on sub-pixels SPX3_N, SPX1_P, SPX4_N, SPX4_P which display the green G.

Referring to FIG. 5B, the first to fourth normal sub-pixels SPX1_N to SPX4_N and the first to fourth private sub-pixels SPX1_P to SPX4_P may operate in a first duration DU1 and a second duration DU2. The first duration DU1 may include a first sub-duration SD1, and the second duration DU2 may include a second sub-duration SD2 and a third sub-duration SD3. In the first sub-duration SD1, each of the first gate signal GS1 and the light-off signal TEST_GATE_OS may have an activation pulse. In the second sub-duration SD2, each of the second gate signal GS2 and the light-off signal TEST_GATE_OS may have the activation pulse. In the third sub-duration SD3, each of the second gate signal GS2, the red light-on signal TEST_GATE_R, and the green light-on signal TEST_GATE_G may have the activation pulse. Here, when a signal applied to a gate electrode of a transistor has the activation pulse, the transistor may be turned on. Therefore, when the transistor is a PMOS transistor, the activation pulse may be a pulse having a relatively low level L.

Referring to FIGS. 5B and 5C, in the first sub-duration SD1, the first transistor T1 may be turned on in response to the light-off signal TEST_GATE_OS having the relatively low level L to provide the first light-off voltage TEST_DATA1 to the first data line DL1. The second transistor T2 may be turned off in response to a red light-on signal TEST_GATE_R having a relatively high level H higher than the relatively low level L. The third transistor T3 may be turned off in response to a blue light-on signal TEST_GATE_B having the relatively high level H. Therefore, the first data line DL1 may transmit the first light-off voltage TEST_DATA1. The first normal sub-pixel SPX1_N may receive the first light-off voltage TEST_DATA1 transmitted through the first data line DL1 in response to the first gate signal GS1 having the relatively low level L. Accordingly, the first normal sub-pixel SPX1_N may light off.

The fourth transistor T4 may be turned on in response to the light-off signal TEST_GATE_OS having the relatively low level L to provide the first light-off voltage TEST_DATA1 to the second data line DL2. The fifth transistor T5 may be turned off in response to a green light-on signal TEST_GATE_G having the relatively high level H. Therefore, the second data line DL2 may transmit the first light-off voltage TEST_DATA1. The third normal sub-pixel SPX3_N may receive the first light-off voltage TEST_DATA1 transmitted through the second data line DL2 in response to the first gate signal GS1 having the relatively low level L. Accordingly, the third normal sub-pixel SPX3_N may light off.

The sixth transistor T6 may be turned on in response to the light-off signal TEST_GATE_OS having the relatively low level L to provide the second light-off voltage TEST_DATA2 to the third data line DL3. The seventh transistor T7 may be turned off in response to the red light-on signal TEST_GATE_R having the relatively high level H. The eighth transistor T8 may be turned off in response to the blue light-on signal TEST_GATE_B having the relatively high level H. Therefore, the third data line DL3 may transmit the second light-off voltage TEST_DATA2. The second private sub-pixel SPX2_P may receive the second light-off voltage TEST_DATA2 transmitted through the third data line DL3 in response to the first gate signal GS1 having the relatively low level L. Accordingly, the second private sub-pixel SPX2_P may light off.

The ninth transistor T9 may be turned on in response to the light-off signal TEST_GATE_OS having the relatively low level L to provide the second light-off voltage TEST_DATA2 to the fourth data line DL4. The tenth transistor T10 may be turned off in response to the green light-on signal TEST_GATE_G having the relatively high level H. Therefore, the fourth data line DL4 may transmit the second light-off voltage TEST_DATA2. The fourth normal sub-pixel SPX4_N may receive the second light-off voltage TEST_DATA2 transmitted through the fourth data line DL4 in response to the first gate signal GS1 having the relatively low level L. Accordingly, the fourth normal sub-pixel SPX4_N may light.

Referring to FIGS. 5B and 5D, in the second sub-duration SD2, the first transistor T1 may be turned on in response to the light-off signal TEST_GATE_OS having the relatively low level L to provide the first light-off voltage TEST_DATA1 to the first data line DL1. The second transistor T2 may be turned off in response to the red light-on signal TEST_GATE_R having the relatively high level H. The third transistor T3 may be turned off in response to the blue light-on signal TEST_GATE_B having the relatively high level H. Therefore, the first data line DL1 may transmit the first light-off voltage TEST_DATA1. The second normal sub-pixel SPX2_N may receive the first light-off voltage TEST_DATA1 transmitted through the first data line DL1 in response to the second gate signal GS2 having the relatively low level L. Accordingly, the second normal sub-pixel SPX2_N may light off.

The fourth transistor T4 may be turned on in response to the light-off signal TEST_GATE_OS having the relatively low level L to provide the first light-off voltage TEST_DATA1 to the second data line DL2. The fifth transistor T5 may be turned off in response to the green light-on signal TEST_GATE_G having the relatively high level H. Therefore, the second data line DL2 may transmit the first light-off voltage TEST_DATA1. The first private sub-pixel SPX1_P may receive the first light-off voltage TEST_DATA1 transmitted through the second data line DL2 in response to the second gate signal GS2 having the relatively low level L. Accordingly, the first private sub-pixel SPX1_P may light off.

The sixth transistor T6 may be turned on in response to the light-off signal TEST_GATE_OS having the relatively low level L to provide the second light-off voltage TEST_DATA2 to the third data line DL3. The seventh transistor T7 may be turned off in response to the red light-on signal TEST_GATE_R having the relatively high level H. The eighth transistor T8 may be turned off in response to the blue light-on signal TEST_GATE_B having the relatively high level H. Therefore, the third data line DL3 may transmit the second light-off voltage TEST_DATA2. The third private sub-pixel SPX3_P may receive the second light-off voltage TEST_DATA2 transmitted through the third data line DL3 in response to the second gate signal GS2 having the relatively low level L. Accordingly, the third private sub-pixel SPX3_P may light off.

The ninth transistor T9 may be turned on in response to the light-off signal TEST_GATE_OS having the relatively low level L to provide the second light-off voltage TEST_DATA2 to the fourth data line DL4. The tenth transistor T10 may be turned off in response to the green light-on signal TEST_GATE_G having the relatively high level H. Therefore, the fourth data line DL4 may transmit the second light-off voltage TEST_DATA2. The fourth private sub-pixel SPX4_P may receive the second light-off voltage TEST_DATA2 transmitted through the fourth data line DL4 in response to the second gate signal GS2 having the relatively low level L. Accordingly, the fourth private sub-pixel SPX4_P may light off.

Referring to FIGS. 5B and 5E, in the third sub-duration SD3, the first transistor T1 may be turned off in response to the light-off signal TEST_GATE_OS having the relatively high level H. The second transistor T2 may be turned on in response to the red light-on signal TEST_GATE_R having the relatively low level L to provide the red voltage DC_R to the first data line DL1. The third transistor T3 may be turned off in response to the blue light-on signal TEST_GATE_B having the relatively high level H. Therefore, the first data line DL1 may transmit the red voltage DC_R. The second normal sub-pixel SPX2_N may receive the red voltage DC_R transmitted through the first data line DL1 in response to the second gate signal GS2 having the relatively low level L. Therefore, the second normal sub-pixel SPX2_N may light on to display the red color R.

The fourth transistor T4 may be turned off in response to the light-off signal TEST_GATE_OS having the relatively high level H. The fifth transistor T5 may be turned on in response to the green light-on signal TEST_GATE_G having the relatively low level L to provide the green voltage DC_G to the second data line DL2. Therefore, the second data line DL2 may transmit the green voltage DC_G. The first private sub-pixel SPX1_P may receive the green voltage DC_G transmitted through the second data line DL2 in response to the second gate signal GS2 having the relatively low level L. Therefore, the first private sub-pixel SPX1_P may light on to display the green G.

The sixth transistor T6 may be turned off in response to the light-off signal TEST_GATE_OS having the relatively high level H. The seventh transistor T7 may be turned on in response to the red light-on signal TEST_GATE_R having the relatively low level L to provide the blue voltage DC_B to the third data line DL3. The eighth transistor T8 may be turned off in response to the blue light-on signal TEST_GATE_B having the relatively high level H. Therefore, the third data line DL3 may transmit the blue voltage DC_B. The third private sub-pixel SPX3_P may receive the blue voltage DC_B transmitted through the third data line DL3 in response to the second gate signal GS2 having the relatively low level L. Therefore, the third private sub-pixel SPX3_P may light on to display the blue color B.

The ninth transistor T9 may be turned off in response to the light-off signal TEST_GATE_OS having the relatively high level H. The tenth transistor T10 may be turned on in response to the green light-on signal TEST_GATE_G having the relatively low level L to provide the green voltage DC_G to the fourth data line DL4. Therefore, the fourth data line DL4 may transmit the green voltage DC_G. The fourth private sub-pixel SPX4_P may receive the green voltage DC_G transmitted through the fourth data line DL4 in response to the second gate signal GS2 having the relatively low level L. Therefore, the fourth private sub-pixel SPX4_P may light on to display the green color G.

As such, in the conventional display cell 200, only the first to fourth private sub-pixels SPX1_P to SPX4_P may not light on. Therefore, a test system may not test whether the private mode will operate normally when the conventional display cell 200 is disposed (e.g., mounted) in a display device. In order to test whether the private mode will operate normally, the second normal sub-pixel SPX2_N should be turned off and the second private sub-pixel SPX2_P should be lit. To this end, the test circuit TC should provide a light-on voltage DC_R, DC_B, or DC_G to at least one of the first to fourth private sub-pixels SPX1_P to SPX4_P independently from the first to fourth normal sub-pixels SPX1_N to SPX4_N. Specifically, when the first gate signal GS1 has the relatively low level L, the third data line DL3 should transmit the red voltage DC_R.

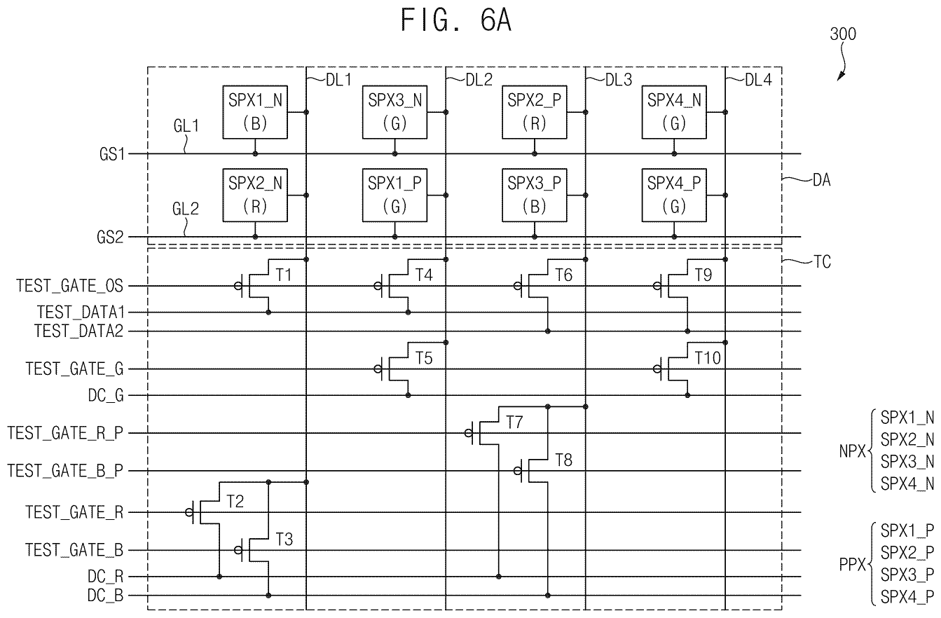

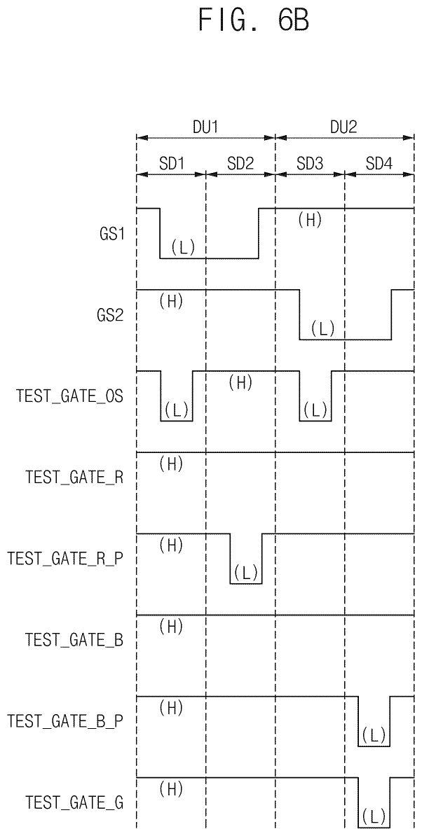

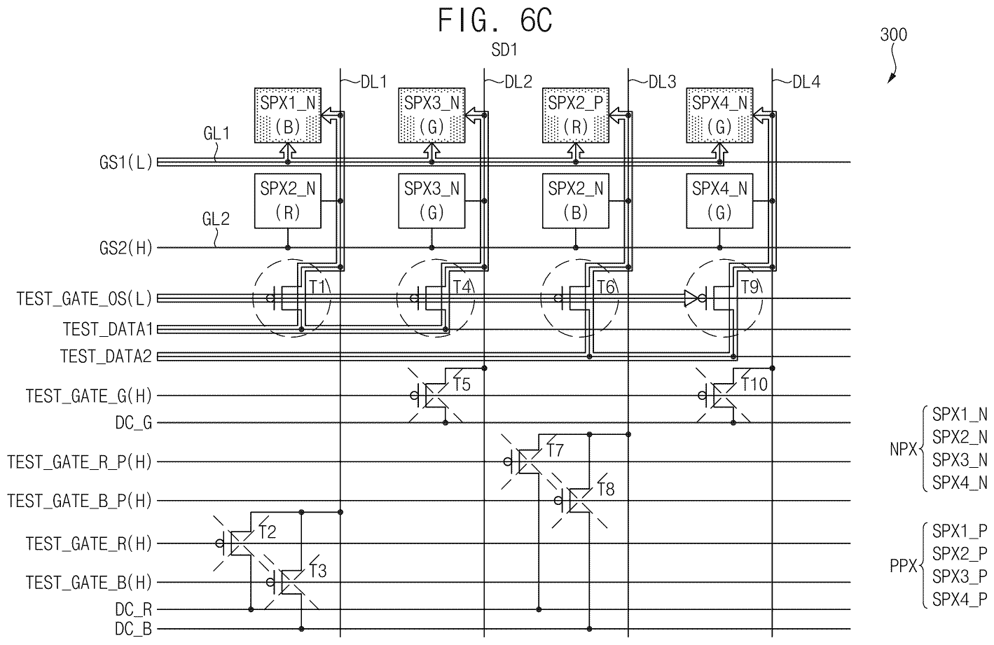

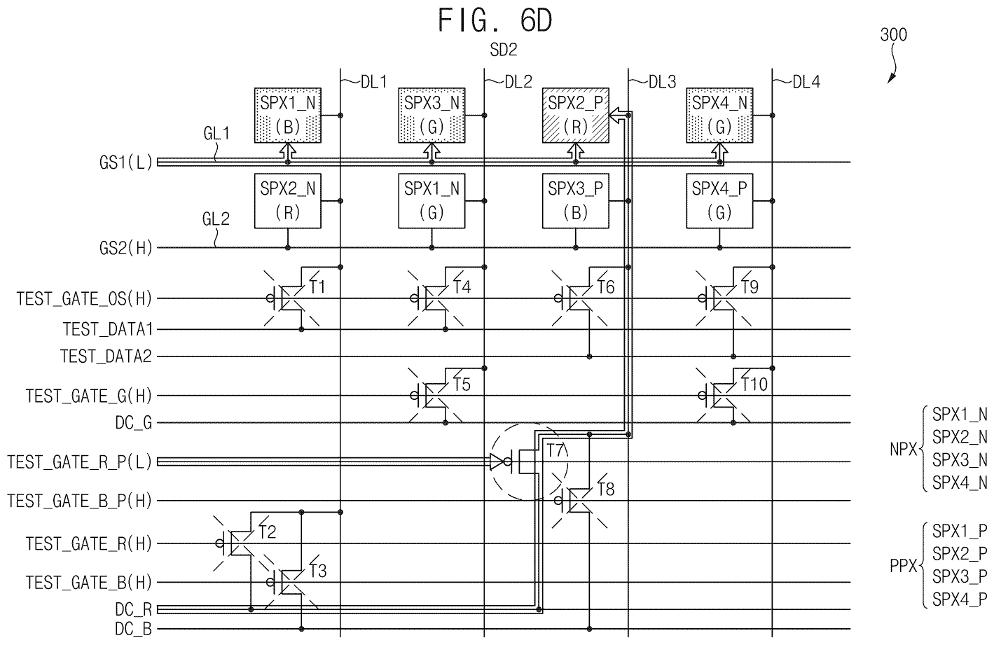

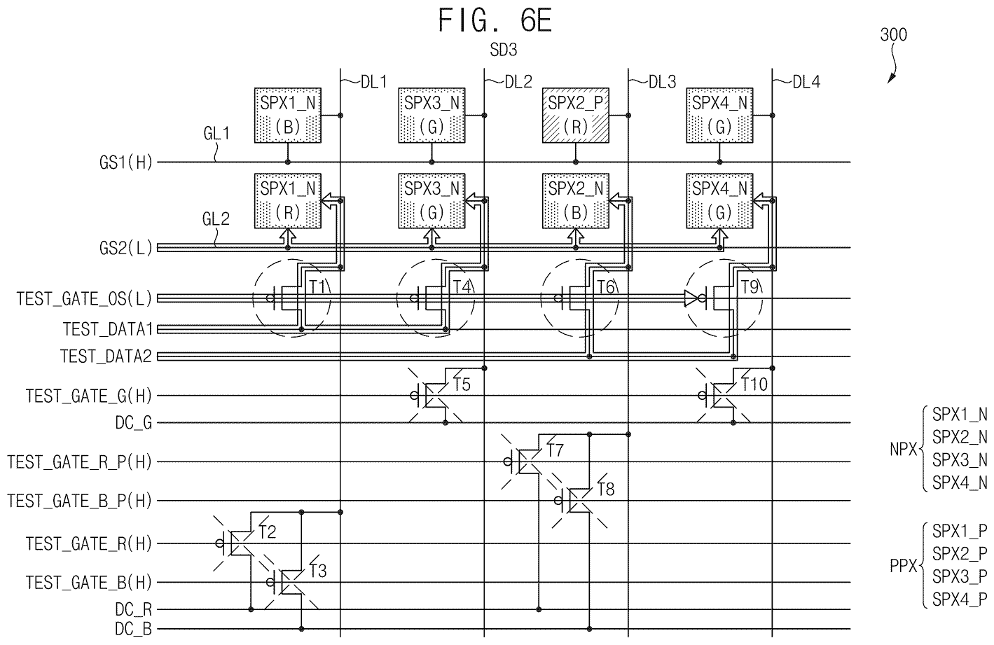

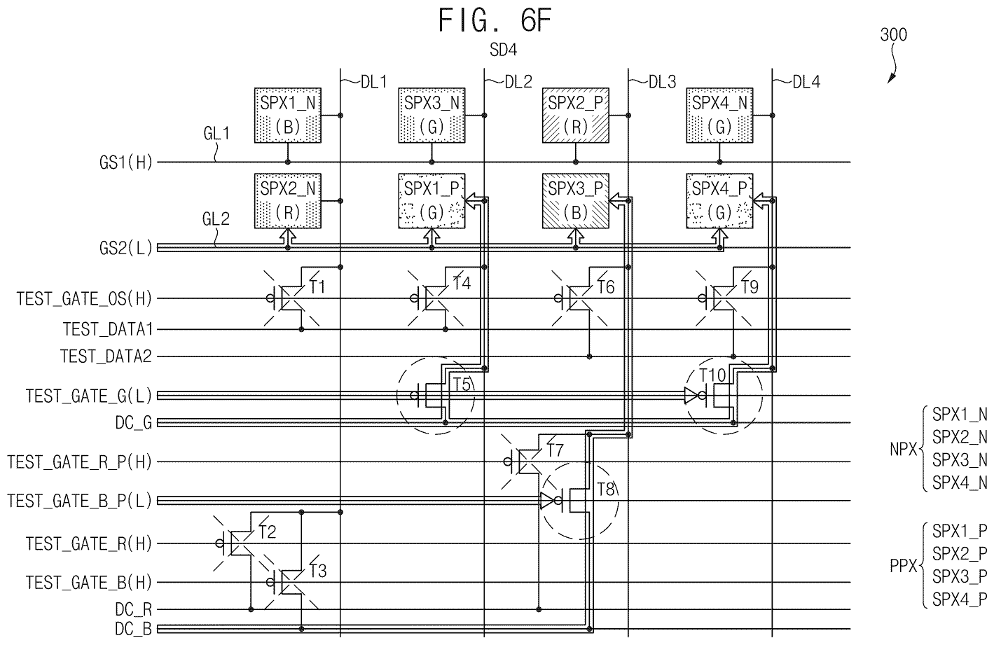

FIG. 6A is a circuit diagram showing an embodiment of a display cell 300 according to the inventive concept. FIG. 6B is a timing diagram showing an embodiment of a signal applied to a display cell 300 in an embodiment of the inventive concept of FIG. 6A. FIG. 6C is a circuit diagram showing an operation of a display cell 300 in an embodiment of the inventive concept of FIG. 6A in a first sub-duration SD1 of FIG. 6B. FIG. 6D is a circuit diagram showing an operation of a display cell 300 in an embodiment of the inventive concept of FIG. 6A in a second sub-duration SD2 of FIG. 6B. FIG. 6E is a circuit diagram showing an operation of a display cell 300 in an embodiment of the inventive concept of FIG. 6A in a third sub-duration SD3 of FIG. 6B. FIG. 6F is a circuit diagram showing an operation of a display cell 300 in an embodiment of the inventive concept of FIG. 6A in a fourth sub-duration SD4 of FIG. 6B.

Referring to FIG. 6A, a display cell 300 in an embodiment of the disclosure may include a display area DA and a test circuit TC.

The display area DA may include a normal pixel NPX and a private pixel PPX. The normal pixel NPX may include first to fourth normal sub-pixels SPX1_N to SPX4_N. The private pixel PPX may include first to fourth private sub-pixels SPX1_P to SPX4_P. In an embodiment, the first normal sub-pixel SPX1_N and the third private sub-pixel SPX3_P may display a blue B. The second normal sub-pixel SPX2_N and the second private sub-pixel SPX2_P may display a red R. The third normal sub-pixel SPX3_N, the first private sub-pixel SPX1_P, the fourth normal sub-pixel SPX4_N, and the fourth private sub-pixel SPX4_P may display a green G.

The first normal sub-pixel SPX1_N and the second normal sub-pixel SPX2_N may be connected to a first data line DL1. The third normal sub-pixel SPX3_N and the first private sub-pixel SPX1_P may be connected to a second data line DL2. The second private sub-pixel SPX2_P and the third private sub-pixel SPX3_P may be connected to a third data line DL3. The fourth normal sub-pixel SPX4_N and the fourth private sub-pixel SPX4_P may be connected to a fourth data line DL4.

The first normal sub-pixel SPX1_N, the third normal sub-pixel SPX3_N, the second private sub-pixel SPX2_P, and the fourth normal sub-pixel SPX4_N may be connected to a first gate line GL1 transmitting a first gate signal GS1. The second normal sub-pixel SPX2_N, the first private sub-pixel SPX1_P, the third private sub-pixel SPX3_P, and the fourth private sub-pixel SPX4_P may be connected to a second gate line GL2 transmitting a second gate signal GS2.

The test circuit TC may include first to tenth transistors T1 to T10. In an embodiment, the first to tenth transistors T1 to T10 may be PMOS transistors.

The first transistor T1 may include a gate electrode receiving a light-off signal TEST_GATE_OS, a first electrode receiving a first light-off voltage TEST_DATA1, and a second electrode connected to the first data line DL1.

The second transistor T2 may include a gate electrode receiving a red light-on signal TEST_GATE_R, a first electrode receiving a red voltage DC_R, and a second electrode connected to the first data line DL1.

The third transistor T3 may include a gate electrode receiving a blue light-on signal TEST_GATE_B, a first electrode receiving a blue voltage DC_B, and a second electrode connected to the first data line DL1.

The fourth transistor T4 may include a gate electrode receiving the light-off signal TEST_GATE_OS, a first electrode receiving the first light-off voltage TEST_DATA1, and a second electrode connected to the second data line DL2.

The fifth transistor T5 may include a gate electrode receiving a green light-on signal TEST_GATE_G, a first electrode receiving a green voltage DC_G, and a second electrode connected to the second data line DL2.

The sixth transistor T6 may include a gate electrode receiving the light-off signal TEST_GATE_OS, a first electrode receiving the second light-off voltage TEST_DATA2, and a second electrode connected to the third data line DL3.

The seventh transistor T7 may include a gate electrode receiving a private red light-switching signal TEST_GATE_R_P, a first electrode receiving the red voltage DC_R, and a second electrode connected to the third data line DL3. In the description, the private red light-switching signal TEST_GATE_R_P having the relatively low level L may be referred to as a private red light-on signal TEST_GATE_R_P, and the private red light-switching signal TEST_GATE_R_P having the relatively high level H may be referred to as a private red light-off signal TEST_GATE_R_P.

The eighth transistor T8 may include a gate electrode receiving a private blue light-switching signal TEST_GATE_B_P, a first electrode receiving the blue voltage DC_B, and a second electrode connected to the third data line DL3. In the description, the private blue light-switching signal TEST_GATE_B_P having the relatively low level L may be referred to as a private blue light-on signal TEST_GATE_B_P, and the private blue light-switching signal TEST_GATE_B_P having the relatively high level H may be referred to as a private blue light-off signal TEST_GATE_B_P.

The ninth transistor T9 may include a gate electrode receiving the light-off signal TEST_GATE_OS, a first electrode receiving the second light-off voltage TEST_DATA2, and a second electrode connected to the fourth data line DL4.

The tenth transistor T10 may include a gate electrode receiving the green light-on signal TEST_GATE_G, a first electrode receiving the green voltage DC_G, and a second electrode connected to the fourth data line DL4.

Referring to FIG. 6B, the first to fourth normal sub-pixels SPX1_N to SPX4_N and the first to fourth private sub-pixels SPX1_P to SPX4_P may operate in a first duration DU1 and a second duration DU2. The first duration DU1 may include a first sub-duration SD1 and a second sub-duration SD2, and the second duration DU2 may include a third sub-duration SD3 and a fourth sub-duration SD4. In the first sub-duration SD1, each of the first gate signal GS1 and the light-off signal TEST_GATE_OS may have an activation pulse. In the second sub-duration SD2, each of the first gate signal GS1 and the private red light-on signal TEST_GATE_R_P may have the activation pulse. In the third sub-duration SD3, each of the second gate signal GS2 and the light-off signal TEST_GATE_OS may have the activation pulse. In the fourth sub-duration SD4, each of the second gate signal GS2, the private blue light-on signal TEST_GATE_B_P, and the green light-on signal TEST_GATE_G may have the activation pulse.

Referring to FIGS. 6B and 6C, in the first sub-duration SD1, the first transistor T1 may be turned on in response to a light-off signal TEST_GATE_OS having a relatively low level L to provide the first light-off voltage TEST_DATA1 to the first data line DL1. The second transistor T2 may be turned off in response to a red light-on signal TEST_GATE_R having a relatively high level H. The third transistor T3 may be turned off in response to a blue light-on signal TEST_GATE_B having the relatively high level H. Therefore, the first data line DL1 may transmit the first light-off voltage TEST_DATA1. The first normal sub-pixel SPX1_N may receive the first light-off voltage TEST_DATA1 transmitted through the first data line DL1 in response to the first gate signal GS1 having the relatively low level L. Accordingly, the first normal sub-pixel SPX1_N may light off.

The fourth transistor T4 may be turned on in response to the light-off signal TEST_GATE_OS having the relatively low level L to provide the first light-off voltage TEST_DATA1 to the second data line DL2. The fifth transistor T5 may be turned off in response to a green light-on signal TEST_GATE_G having the relatively high level H. Therefore, the second data line DL2 may transmit the first light-off voltage TEST_DATA1. The third normal sub-pixel SPX3_N may receive the first light-off voltage TEST_DATA1 transmitted through the second data line DL2 in response to the first gate signal GS1 having the relatively low level L. Accordingly, the third normal sub-pixel SPX3_N may light off.

The sixth transistor T6 may be turned on in response to the light-off signal TEST_GATE_OS having the relatively low level L to provide a second light-off voltage TEST_DATA2 to the third data line DL3. The seventh transistor T7 may be turned off in response to a private red light-off signal TEST_GATE_R_P having the relatively high level H. The eighth transistor T8 may be turned off in response to a private blue light-off signal TEST_GATE_B_P having the relatively high level H. Therefore, the third data line DL3 may transmit the second light-off voltage TEST_DATA2. The second private sub-pixel SPX2_P may receive the second light-off voltage TEST_DATA2 transmitted through the third data line DL3 in response to the first gate signal GS1 having the relatively low level L. Accordingly, the second private sub-pixel SPX2_P may light off.

The ninth transistor T9 may be turned on in response to the light-off signal TEST_GATE_OS having the relatively low level L to provide the second light-off voltage TEST_DATA2 to the fourth data line DL4. The tenth transistor T10 may be turned off in response to the green light-on signal TEST_GATE_G having the relatively high level H. Therefore, the fourth data line DL4 may transmit the second light-off voltage TEST_DATA2. The fourth normal sub-pixel SPX4_N may receive the second light-off voltage TEST_DATA2 transmitted through the fourth data line DL4 in response to the first gate signal GS1 having the relatively low level L. Accordingly, the fourth normal sub-pixel SPX4_N may light off.

Referring to FIGS. 6B and 6D, in the second sub-duration SD2, the first transistor T1 may be turned off in response to a light-off signal TEST_GATE_OS having the relatively high level H. The second transistor T2 may be turned off in response to the red light-on signal TEST_GATE_R having the relatively high level H. The third transistor T3 may be turned off in response to the blue light-on signal TEST_GATE_B having the relatively high level H. Therefore, the first normal sub-pixel SPX1_N may maintain a previous state (i.e., a light-off state).

The fourth transistor T4 may be turned off in response to the light-off signal TEST_GATE_OS having the relatively high level H. The fifth transistor T5 may be turned off in response to the green light-on signal TEST_GATE_G having the relatively high level H. Therefore, the third normal sub-pixel SPX3_N may maintain a previous state (i.e., the off state).

The sixth transistor T6 may be turned off in response to the light-off signal TEST_GATE_OS having the relatively high level H. The seventh transistor T7 may be turned on in response to a private red light-on signal TEST_GATE_R_P having the relatively low level L to provide a red voltage DC_R to the third data line DL3. The third data line DL3 may transmit the red voltage DC_R. The second private sub-pixel SPX2_P may receive the red voltage DC_R transmitted through the third data line DL3 in response to the first gate signal GS1 having the relatively low level L. Accordingly, the second private sub-pixel SPX2_P may light on to display the red R.

The ninth transistor T9 may be turned off in response to the light-off signal TEST_GATE_OS having the relatively high level H. The tenth transistor T10 may be turned off in response to the green light-on signal TEST_GATE_G having the relatively high level H. Therefore, the fourth normal sub-pixel SPX4_N may maintain a previous state (i.e., the light-off state).

Referring to FIGS. 6B and 6E, in the third sub-duration SD3, the first transistor T1 may be turned on in response to the light-off signal TEST_GATE_OS having the relatively low level L to provide the first light-off voltage TEST_DATA1 to the first data line DL1. The second transistor T2 may be turned off in response to the red light-on signal TEST_GATE_R having the relatively high level H. The third transistor T3 may be turned off in response to the blue light-on signal TEST_GATE_B having the relatively high level H. Therefore, the first data line DL1 may transmit the first light-off voltage TEST_DATA1. The second normal sub-pixel SPX2_N may receive the first light-off voltage TEST_DATA1 transmitted through the first data line DL1 in response to the second gate signal GS2 having the relatively low level L. Accordingly, the second normal sub-pixel SPX2_N may light off.

The fourth transistor T4 may be turned on in response to the light-off signal TEST_GATE_OS having the relatively low level L to provide the first light-off voltage TEST_DATA1 to the second data line DL2. The fifth transistor T5 may be turned off in response to the green light-on signal TEST_GATE_G having the relatively high level H. Therefore, the second data line DL2 may transmit the first light-off voltage TEST_DATA1. The first private sub-pixel SPX1_P may receive the first light-off voltage TEST_DATA1 transmitted through the second data line DL2 in response to the second gate signal GS2 having the relatively low level L. Accordingly, the first private sub-pixel SPX1_N may light off.

The sixth transistor T6 may be turned on in response to the light-off signal TEST_GATE_OS having the relatively low level L to provide the second light-off voltage TEST_DATA2 to the third data line DL3. The seventh transistor T7 may be turned off in response to the private red light-on signal TEST_GATE_R_P having the relatively high level H. The eighth transistor T8 may be turned off in response to the private blue light-on signal TEST_GATE_B_P having the relatively high level H. Therefore, the third data line DL3 may transmit the second light-off voltage TEST_DATA2. The third private sub-pixel SPX3_P may receive the second light-off voltage TEST_DATA2 transmitted through the third data line DL3 in response to the second gate signal GS2 having the relatively low level L. Accordingly, the third private sub-pixel SPX3_P may light off.

The ninth transistor T9 may be turned on in response to the light-off signal TEST_GATE_OS having the relatively low level L to provide the second light-off voltage TEST_DATA2 to the fourth data line DL4. The tenth transistor T10 may be turned off in response to the green light-off signal TEST_GATE_G having the relatively high level H. Therefore, the fourth data line DL4 may transmit the second light-off voltage TEST_DATA2. The fourth private sub-pixel SPX4_P may receive the second light-off voltage TEST_DATA2 transmitted through the fourth data line DL4 in response to the second gate signal GS2 having the relatively low level L. Accordingly, the fourth private sub-pixel SPX4_P may light off.

Referring to FIGS. 6B and 6F, in the fourth sub-duration SD4, the first transistor T1 may be turned off in response to the light-off signal TEST_GATE_OS having the relatively high level H. The second transistor T2 may be turned off in response to the red light-on signal TEST_GATE_R having the relatively high level H. The third transistor T3 may be turned off in response to the blue light-on signal TEST_GATE_B having the relatively high level H. Therefore, the fourth normal sub-pixel SPX4_N may maintain a previous state (i.e., the light-off state).

The fourth transistor T4 may be turned off in response to the light-off signal TEST_GATE_OS having the relatively high level H. The fifth transistor T5 may be turned on in response to the green light-on signal TEST_GATE_G having the relatively low level L to provide a green voltage DC_G to the second data line DL2. Therefore, the second data line DL2 may transmit the green voltage DC_G. The first private sub-pixel SPX1_P may receive the green voltage DC_G transmitted through the second data line DL2 in response to the second gate signal GS2 having the relatively low level L. The first private sub-pixel SPX1_P may be turned on to display the green color G.

The sixth transistor T6 may be turned off in response to the light-off signal TEST_GATE_OS having the relatively high level H. The seventh transistor T7 may be turned off in response to the private red light-on signal TEST_GATE_R_P having the relatively high level H. The eighth transistor T8 may be turned on in response to a private blue light-on signal TEST_GATE_B_P having the relatively low level L to provide a blue voltage DC_B to the third data line DL3. Therefore, the third data line DL3 may transmit the blue voltage DC_B. The third private sub-pixel SPX3_P may be turned on to display the blue color B.

The ninth transistor T9 may be turned off in response to the light-off signal TEST_GATE_OS having the relatively high level H. The tenth transistor T10 may be turned on in response to the green light-on signal TEST_GATE_G having the relatively low level L to provide the green voltage DC_G to the fourth data line DL4. Therefore, the fourth data line DL4 may transmit the green voltage DC_G. The fourth private sub-pixel SPX4_P may receive the green voltage DC_G transmitted through the fourth data line DL4 in response to the second gate signal GS2 having the relatively low level L. Therefore, the fourth private sub-pixel SPX4_P may be turned on to display the green color G.

As such, in the display cell 300 in an embodiment of the inventive concept, the test circuit TC may provide the light-on voltage DC_R, DC_B, or DC_G to at least one of the first to fourth private sub-pixels SPX1_P to SPX4_P independently from the first to fourth normal sub-pixels SPX1_N to SPX4_N. Specifically, when the first gate signal GS1 has the relatively low level L, the third data line DL3 may transmit the red voltage DC_R. Accordingly, whether the private mode is normally operated may be tested.

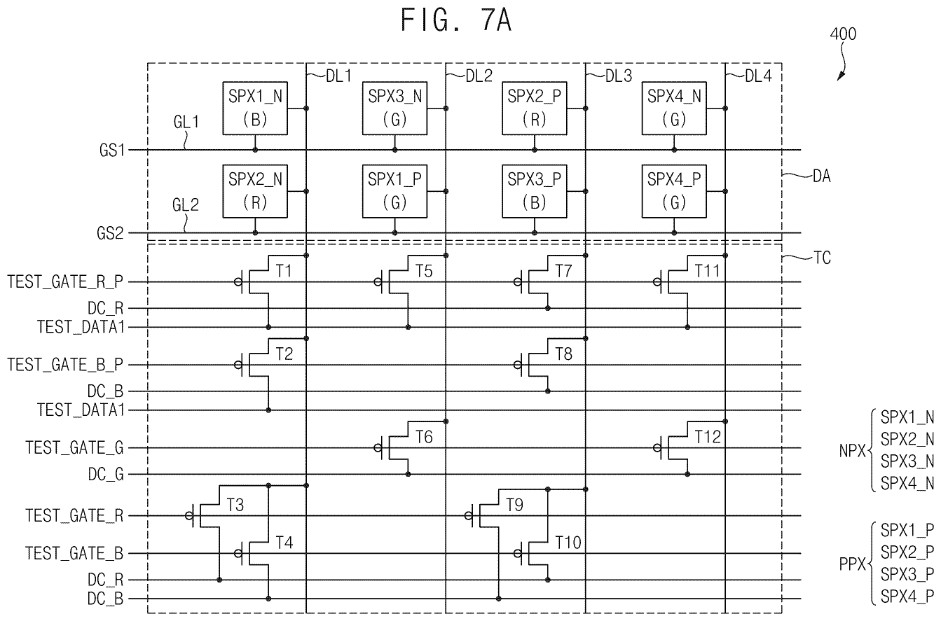

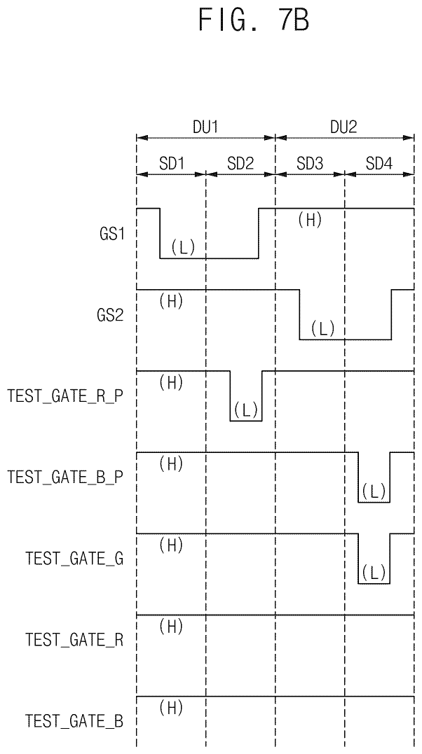

FIG. 7A is a circuit diagram showing an embodiment of a display cell 400 according to the inventive concept. FIG. 7B is a timing diagram showing a signal applied to a display cell 400 in an embodiment of the inventive concept of FIG. 7A.

Referring to FIG. 7A, a display cell 400 in an embodiment of the inventive concept may include a display area DA and a test circuit TC.

The display area DA may include a normal pixel NPX and a private pixel PPX. The normal pixel NPX may include first to fourth normal sub-pixels SPX1_N to SPX4_N. The private pixel PPX may include first to fourth private sub-pixels SPX1_P to SPX4_P. In an embodiment, the first normal sub-pixel SPX1_N and the third private sub-pixel SPX3_P may display a blue B. The second normal sub-pixel SPX2_N and the second private sub-pixel SPX2_P may display a red R. The third normal sub-pixel SPX3_N, the first private sub-pixel SPX1_P, the fourth normal sub-pixel SPX4_N, and the fourth private sub-pixel SPX4_P may display a green G.

The first normal sub-pixel SPX1_N and the second normal sub-pixel SPX2_N may be connected to a first data line DL1. The third normal sub-pixel SPX3_N and the first private sub-pixel SPX1_P may be connected to a second data line DL2. The second private sub-pixel SPX2_P and the third private sub-pixel SPX3_P may be connected to a third data line DL3. The fourth normal sub-pixel SPX4_N and the fourth private sub-pixel SPX4_P may be connected to a fourth data line DL4.

The first normal sub-pixel SPX1_N, the third normal sub-pixel SPX3_N, the second private sub-pixel SPX2_P, and the fourth normal sub-pixel SPX4_N may be connected to a first gate line GL1 transmitting a first gate signal GS1. The second normal sub-pixel SPX2_N, the first private sub-pixel SPX1_P, the third private sub-pixel SPX3_P, and the fourth private sub-pixel SPX4_P may be connected to a second gate line GL2 transmitting a second gate signal GS2.

The test circuit TC may include first to twelfth transistors T1 to T12. In an embodiment, the first to twelfth transistors T1 to T12 may be PMOS transistors.

The first transistor T1 may include a gate electrode receiving a private red light-on signal TEST_GATE_R_P, a first electrode receiving a first light-off voltage TEST_DATA1, and a second electrode connected to the first data line DL1.

The second transistor T2 may include a gate electrode receiving a private blue light-on signal TEST_GATE_B_P, a first electrode receiving the first light-off voltage TEST_DATA1, and a second electrode connected to the first data line DL1.

The third transistor T3 may include a gate electrode receiving a red light-on signal TEST_GATE_R, a first electrode receiving a red voltage DC_R, and a second electrode connected to the first data line DL1.

The fourth transistor T4 may include a gate electrode receiving a blue light-on signal TEST_GATE_B, a first electrode receiving a blue voltage DC_B, and a second electrode connected to the first data line DL1.

The fifth transistor T5 may include a gate electrode receiving the private red light-on signal TEST_GATE_R_P, a first electrode receiving the first light-off voltage TEST_DATA1, and a second electrode connected to the second data line DL2.

The sixth transistor T6 may include a gate electrode receiving a green light-on signal TEST_GATE_G, a first electrode receiving a green voltage DC_G, and a second electrode connected to the second data line DL2.

The seventh transistor T7 may include a gate electrode receiving the private red light-on signal TEST_GATE_R_P, a first electrode receiving a red voltage DC_R, and a second electrode connected to the third data line DL3.

The eighth transistor T8 may include a gate electrode receiving the private blue light-on signal TEST_GATE_B_P, a first electrode receiving the blue voltage DC_B, and a second electrode connected to the third data line DL3.

The ninth transistor T9 may include a gate electrode receiving the red light-on signal TEST_GATE_R, a first electrode receiving the blue voltage DC_B, and a second electrode connected to the third data line DL3.

The tenth transistor T10 may include a gate electrode receiving the blue light-on signal TEST_GATE_B, a first electrode receiving the red voltage DC_R, and a second electrode connected to the third data line DL3.

The eleventh transistor T11 may include a gate electrode receiving the private red light-on signal TEST_GATE_R_P, a first electrode receiving the first light-off voltage TEST_DATA1, and a second electrode connected to the fourth data line DL4.

The twelfth transistor T12 may include a gate electrode receiving the green light-on signal TEST_GATE_G, a first electrode receiving the green voltage DC_G, and a second electrode connected to the fourth data line DL4.

Referring to FIG. 7B, the first to fourth normal sub-pixels SPX1_N to SPX4_N and the first to fourth private sub-pixels SPX1_P to SPX4_P may operate in a first duration DU1 and a second duration DU2. The first duration DU1 may include a first sub-duration SD1 and a second sub-duration SD2, and the second duration DU2 may include a third sub-duration SD3 and a fourth sub-duration SD4. In the first sub-duration SD1, the first gate signal GS1 may have an activation pulse. In the second sub-duration SD2, each of the first gate signal GS1 and the private red light-on signal TEST_GATE_R_P may have the activation pulse. In the third sub-duration SD3, the second gate signal GS2 may have the activation pulse. In the fourth sub-duration SD4, each of the second gate signal GS2, the private blue light-on signal TEST_GATE_B_P, and the green light-on signal TEST_GATE_G may have the activation pulse.

In the second sub-duration SD2, in response to a first gate signal GS1 having a relatively low level L and a private red light-on signal TEST_GATE_R_P having the relatively low level L, the first normal sub-pixel SPX1_N, the third normal sub-pixel SPX3_N, and the fourth normal sub-pixel SPX4 may light off, and the second private sub-pixel SPX2_P may light on to display the red R. In the fourth sub-duration SD4, in response to the second gate signal GS2 having the relatively low level L, the private blue light-on signal TEST_GATE_B_P having the relatively low level L, and the green light-on signal TEST_GATE_G having the relatively low level L, the second normal sub-pixel SPX2_N may light off, the first private sub-pixel SPX1_P may light on to display the green G, the third private sub-pixel SPX3_P may light on to display the blue B, and the fourth private sub-pixel SPX4_P may light on to display the green G.

As such, in the display cell 400 in an embodiment of the inventive concept, the test circuit TC may provide the light-on voltage DC_R, DC_B, or DC_G to at least one of the first to fourth private sub-pixels SPX1_P to SPX4_P independently from the first to fourth normal sub-pixels SPX1_N to SPX4_N. Specifically, when the first gate signal GS1 has the relatively low level L, the third data line DL3 may transmit the red voltage DC_R. Accordingly, whether the private mode is operated normally may be tested.

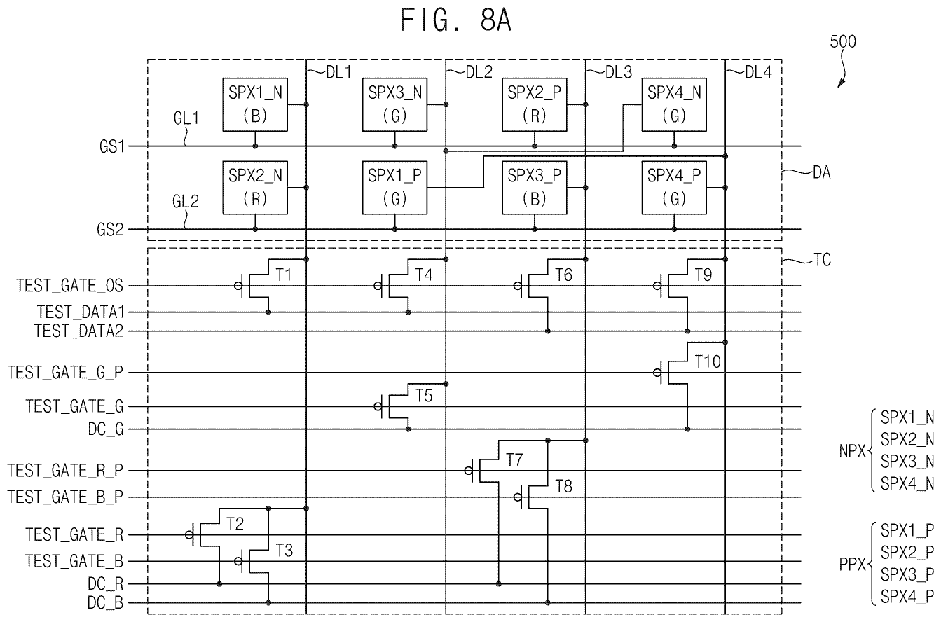

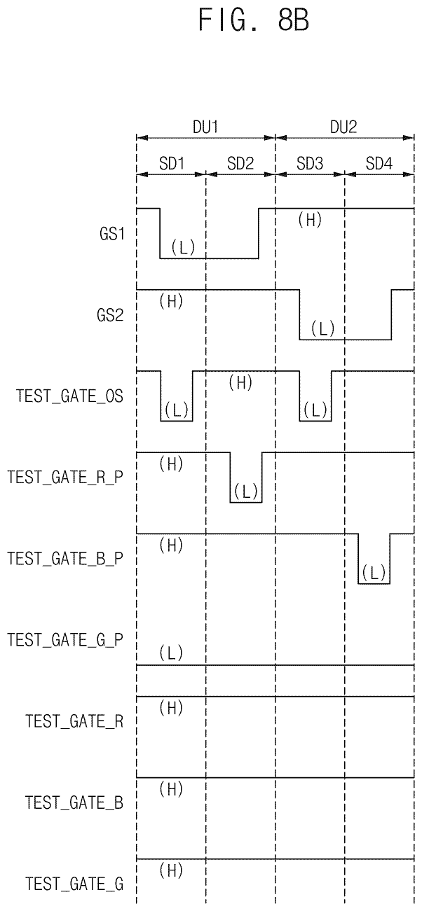

FIG. 8A is a circuit diagram showing an embodiment of a display cell 500 according to the inventive concept. FIG. 8B is a timing diagram showing a signal applied to a display cell 500 in an embodiment of the inventive concept of FIG. 8A.

Referring to FIG. 8A, a display cell 500 in an embodiment of the inventive concept may include a display area DA and a test circuit TC.

The display area DA may include a normal pixel NPX and a private pixel PPX. The normal pixel NPX may include first to fourth normal sub-pixels SPX1_N to SPX4_N. The private pixel PPX may include first to fourth private sub-pixels SPX1_P to SPX4_P. In an embodiment, the first normal sub-pixel SPX1_N and the third private sub-pixel SPX3_P may display a blue B. The second normal sub-pixel SPX2_N and the second private sub-pixel SPX2_P may display a red R. The third normal sub-pixel SPX3_N, the first private sub-pixel SPX1_P, the fourth normal sub-pixel SPX4_N, and the fourth private sub-pixel SPX4_P may display a green G.

The first normal sub-pixel SPX1_N and the second normal sub-pixel SPX2_N may be connected to a first data line DL1. The third normal sub-pixel SPX3_N and the fourth normal sub-pixel SPX4_N may be connected to a second data line DL2. The second private sub-pixel SPX2_P and the third private sub-pixel SPX3_P may be connected to a third data line DL3. The first private sub-pixel SPX1_P and the fourth private sub-pixel SPX4_P may be connected to a fourth data line DL4.

The first normal sub-pixel SPX1_N, the third normal sub-pixel SPX3_N, the second private sub-pixel SPX2_P, and the fourth normal sub-pixel SPX4_N may be connected to a first gate line GL1 transmitting a first gate signal GS1. The second normal sub-pixel SPX2_N, the first private sub-pixel SPX1_P, the third private sub-pixel SPX3_P, and the fourth private sub-pixel SPX4_P may be connected to a second gate line GL2 transmitting a second gate signal GS2.

The test circuit TC may include first to tenth transistors T1 to T10. In an embodiment, the first to tenth transistors T1 to T10 may be PMOS transistors.

The first transistor T1 may include a gate electrode receiving a light-off signal TEST_GATE_OS, a first electrode receiving a first light-off voltage TEST_DATA1, and a second electrode connected to the first data line DL1.

The second transistor T2 may include a gate electrode receiving a red light-on signal TEST_GATE_R, a first electrode receiving a red voltage DC_R, and a second electrode connected to the first data line DL1.

The third transistor T3 may include a gate electrode receiving a blue light-on signal TEST_GATE_B, a first electrode receiving a blue voltage DC_B, and a second electrode connected to the first data line DL1.

The fourth transistor T4 may include a gate electrode receiving the light-off signal TEST_GATE_OS, a first electrode receiving the first light-off voltage TEST_DATA1, and a second electrode connected to the second data line DL2.

The fifth transistor T5 may include a gate electrode receiving a green light-on signal TEST_GATE_G, a first electrode receiving a green voltage DC_G, and a second electrode connected to the second data line DL2.

The sixth transistor T6 may include a gate electrode receiving the light-off signal TEST_GATE_OS, a first electrode receiving a second light-off voltage TEST_DATA2, and a second electrode connected to the third data line DL3.

The seventh transistor T7 may include a gate electrode receiving a private red light-on signal TEST_GATE_R_P, a first electrode receiving the red voltage DC_R, and a second electrode connected to the third data line DL3.

The eighth transistor T8 may include a gate electrode receiving a private blue light-on signal TEST_GATE_B_P, a first electrode receiving the blue voltage DC_B, and a second electrode connected to the third data line DL3.

The ninth transistor T9 may include a gate electrode receiving the light-off signal TEST_GATE_OS, a first electrode receiving the second light-off voltage TEST_DATA2, and a second electrode connected to the fourth data line DL4.

The tenth transistor T10 may include a gate electrode receiving a private green light-on signal TEST_GATE_G_P, a first electrode receiving the green voltage DC_G, and a second electrode connected to the fourth data line DL4.

Referring to FIG. 8B, the first to fourth normal sub-pixels SPX1_N to SPX4_N and the first to fourth private sub-pixels SPX1_P to SPX4_P may operate in a first duration DU1 and a second duration DU2. The first duration DU1 may include a first sub-duration SD1 and a second sub-duration SD2, and the second duration DU2 may include a third sub-duration SD3 and a fourth sub-duration SD4. In the first sub-duration SD1, each of the first gate signal GS1 and the light-off signal TEST_GATE_OS may have an activation pulse. In the second sub-duration SD2, each of the first gate signal GS1 and the private red light-on signal TEST_GATE_R_P may have the activation pulse. In the third sub-duration SD3, each of the second gate signal GS2 and the light-off signal TEST_GATE_OS may have the activation pulse. In the fourth sub-duration SD4, each of the second gate signal GS2 and the private blue light-on signal TEST_GATE_B_P may have the activation pulse.

In the first sub-duration SD1, in response to a first gate signal GS1 having a relatively low level L and a light-off signal TEST_GATE_OS having the relatively low level L, the first normal sub-pixel SPX1_N, the third normal sub-pixel SPX3_N, the second private sub-pixel SPX2_P, and the fourth normal sub-pixel SPX4_N may light off. In the second sub-duration SD2, in response to the first gate signal GS1 having the relatively low level L and a private red light-on signal TEST_GATE_R_P having the relatively low level L, the second private sub-pixel SPX2_P may light on to display the red color R. In the third sub-duration SD3, in response to the second gate signal GS2 having the relatively low level L and the light-off signal TEST_GATE_OS having the relatively low level L, the second normal sub-pixel SPX2_N, the first private sub-pixel SPX1_P, the third private sub-pixel SPX3_P, and the fourth private sub-pixel SPX4_P may light off. In the fourth sub-duration SD4, in response to the second gate signal GS2 having the relatively low level L, the private blue light-on signal TEST_GATE_B_P having the relatively low level L, and the private green light-on signal TEST_GATE_G_P having the relatively low level L, the first private sub-pixel SPX1_P may light on to display the green G, the third private sub-pixel SPX3_P may light on to display the blue B, and the fourth private sub-pixel SPX4_P may light on to display the green G.

As such, in the display cell 500 in an embodiment of the inventive concept, the test circuit TC may provide a light-on voltage DC_R, DC_B, or DC_G to at least one of the first to fourth private sub-pixels SPX1_P to SPX4_P independently from the first to fourth normal sub-pixels SPX1_N to SPX4_N. Specifically, when the first gate signal GS1 has the relatively low level L, the third data line DL3 may transmit the red voltage DC_R. Accordingly, whether the private mode is normally operated may be tested.

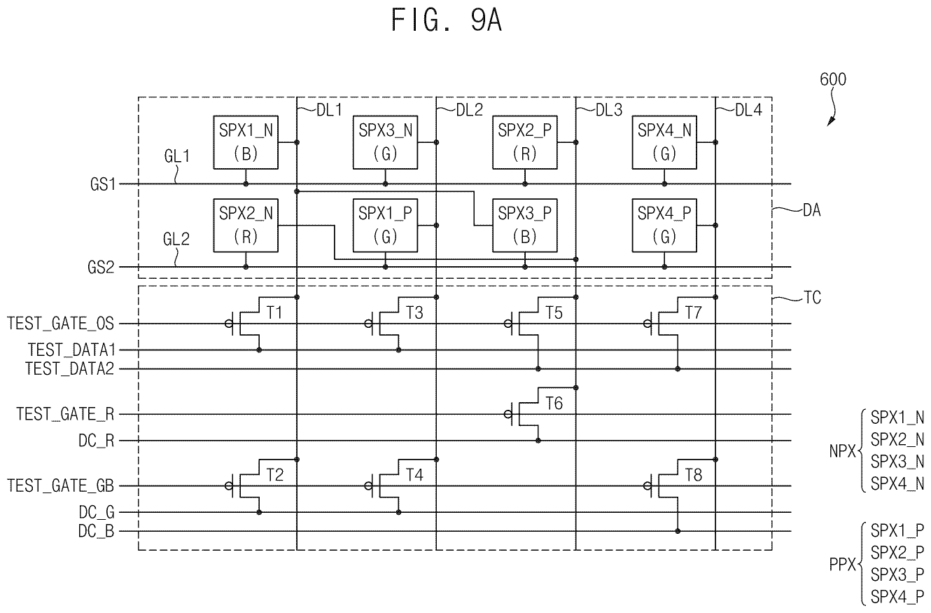

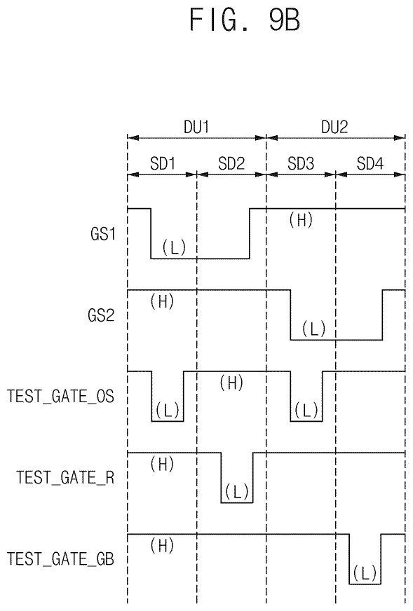

FIG. 9A is a circuit diagram showing an embodiment of a display cell 600 according to the inventive concept. FIG. 9B is a timing diagram showing a signal applied to a display cell 600 in an embodiment of the disclosure of FIG. 9A.

Referring to FIG. 9A, a display cell 600 in an embodiment of the inventive concept may include a display area DA and a test circuit TC.

The display area DA may include a normal pixel NPX and a private pixel PPX. The normal pixel NPX may include first to fourth normal sub-pixels SPX1_N to SPX4_N. The private pixel PPX may include first to fourth private sub-pixels SPX1_P to SPX4_P. In an embodiment, the first normal sub-pixel SPX1_N and the third private sub-pixel SPX3_P may display a blue B. The second normal sub-pixel SPX2_N and the second private sub-pixel SPX2_P may display a red R. The third normal sub-pixel SPX3_N, the first private sub-pixel SPX1_P, the fourth normal sub-pixel SPX4_N, and the fourth private sub-pixel SPX4_P may display a green G.

The first normal sub-pixel SPX1_N and the third private sub-pixel SPX3_P may be connected to a first data line DL1. The third normal sub-pixel SPX3_N and the first private sub-pixel SPX1_P may be connected to a second data line DL2. The second normal sub-pixel SPX2_N and the second private sub-pixel SPX2_P may be connected to a third data line DL3. The fourth normal sub-pixel SPX4_N and the fourth private sub-pixel SPX4_P may be connected to a fourth data line DL4.

The first normal sub-pixel SPX1_N, the third normal sub-pixel SPX3_N, the second private sub-pixel SPX2_P, and the fourth normal sub-pixel SPX4_N may be connected to a first gate line GL1 transmitting a first gate signal GS1. The second normal sub-pixel SPX2_N, the first private sub-pixel SPX1_P, the third private sub-pixel SPX3_P, and the fourth private sub-pixel SPX4_P may be connected to a second gate line GL2 transmitting a second gate signal GS2.

The test circuit TC may include first to eighth transistors T1 to T8. In an embodiment, the first to eighth transistors T1 to T8 may be PMOS transistors.

The first transistor T1 may include a gate electrode receiving a light-off signal TEST_GATE_OS, a first electrode receiving a first light-off voltage TEST_DATA1, and a second electrode connected to the first data line DL1.

The second transistor T2 may include a gate electrode receiving a green-blue light-on signal TEST_GATE_GB, a first electrode receiving a blue voltage DC_B, and a second electrode connected to the first data line DL1.

The third transistor T3 may include a gate electrode receiving the light-off signal TEST_GATE_OS, a first electrode receiving the first light-off voltage TEST_DATA1, and a second electrode connected to the second data line DL2.

The fourth transistor T4 may include a gate electrode receiving the green-blue light-on signal TEST_GATE_GB, a first electrode receiving a green voltage DC_G, and a second electrode connected to the second data line DL2.

The fifth transistor T5 may include a gate electrode receiving the light-off signal TEST_GATE_OS, a first electrode receiving a second light-off voltage TEST_DATA2, and a second electrode connected to the third data line DL3.

The sixth transistor T6 may include a gate electrode receiving a red light-on signal TEST_GATE_R, a first electrode receiving a red voltage DC_R, and a second electrode connected to the third data line DL3.

The seventh transistor T7 may include a gate electrode receiving the light-off signal TEST_GATE_OS, a first electrode receiving the second light-off voltage TEST_DATA2, and a second electrode connected to the fourth data line DL4.

The eighth transistor T8 may include a gate electrode receiving the green-blue light-off signal TEST_GATE_GB, a first electrode receiving the green voltage DC_G, and a second electrode connected to the fourth data line DL4.

Referring to FIG. 9B, the first to fourth normal sub-pixels SPX1_N to SPX4_N and the first to fourth private sub-pixels SPX1_P to SPX4_P may operate in a first duration DU1 and a second duration DU2. The first duration DU1 may include a first sub-duration SD1 and a second sub-duration SD2, and the second duration DU2 may include a third sub-duration SD3 and a fourth sub-duration SD4. In the first sub-duration SD1, each of the first gate signal GS1 and the light-off signal TEST_GATE_OS may have an activation pulse. In the second sub-duration SD2, each of the first gate signal GS1 and the red light-on signal TEST_GATE_R may have the activation pulse. In the third sub-duration SD3, each of the second gate signal GS2 and the light-off signal TEST_GATE_OS may have the activation pulse. In the fourth sub-duration SD4, each of the second gate signal GS2 and the green-blue light-on signal TEST_GATE_GB may have the activation pulse.

In the first sub-duration SD1, in response to a first gate signal GS1 having a relatively low level L and a light-off signal TEST_GATE_OS having the relatively low level L, the first normal sub-pixel SPX1_N, the third normal sub-pixel SPX3_N, the second private sub-pixel SPX2_P, and the fourth normal sub-pixel SPX4_N may light off. In the second sub-duration SD2, in response to the first gate signal GS1 having the relatively low level L and a red light-on signal TEST_GATE_R having the relatively low level L, the second private sub-pixel SPX2_P may light on to display the red color R. In the third sub-duration SD3, in response to a second gate signal GS2 having the relatively low level L and the light-off signal TEST_GATE_OS having the relatively low level L, the second normal sub-pixel SPX2_N, the first private sub-pixel SPX1_P, the third private sub-pixel SPX3_P, and the fourth private sub-pixel SPX4_P may light off. In the fourth sub-duration SD4, in response to a second gate signal GS2 having the relatively low level L and a green-blue light-on signal TEST_GATE_GB having the relatively low level L, the first private sub-pixel SPX1_P may light on to display the green G, the third private sub-pixel SPX3_P may light on to display the blue B, and the fourth private sub-pixel SPX4_P may light on to display the green G.

As such, in the display cell 600 in an embodiment of the inventive concept, the test circuit TC may provide a light-on voltage DC_R, DC_B, or DC_G to at least one of the first to fourth private sub-pixels SPX1_P to SPX4_P independently from the first to fourth normal sub-pixels SPX1_N to SPX4_N. Specifically, when the first gate signal GS1 has the relatively low level L, the third data line DL3 may transmit the red voltage DC_R. Accordingly, whether the private mode operates normally may be tested.

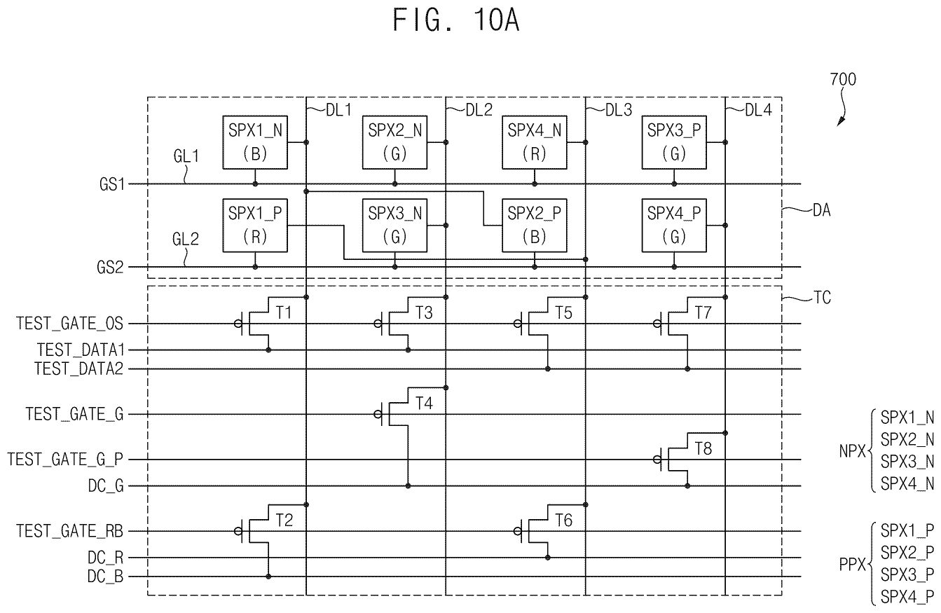

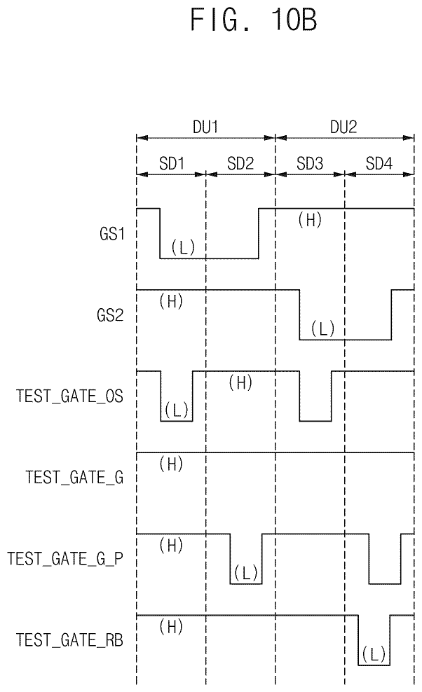

FIG. 10A is a circuit diagram showing an embodiment of a display cell 700 according to the inventive concept. FIG. 10B is a timing diagram showing a signal applied to a display cell 700 in an embodiment of the inventive concept of FIG. 10A.

Referring to FIG. 10A, a display cell 700 in an embodiment of the inventive concept may include a display area DA and a test circuit TC.

The display area DA may include a normal pixel NPX and a private pixel PPX. The normal pixel NPX may include first to fourth normal sub-pixels SPX1_N to SPX4_N. The private pixel PPX may include first to fourth private sub-pixels SPX1_P to SPX4_P. In an embodiment, the first normal sub-pixel SPX1_N and the second private sub-pixel SPX2_P may display a blue B. The first private sub-pixel SPX1_P and the fourth normal sub-pixel SPX4_N may display a red R. The second normal sub-pixel SPX2_N, the third normal sub-pixel SPX3_N, the third private sub-pixel SPX3_P, and the fourth private sub-pixel SPX4_P may display a green G.

The first normal sub-pixel SPX1_N and the second private sub-pixel SPX2_P may be connected to a first data line DL1. The second normal sub-pixel SPX2_N and the third normal sub-pixel SPX3_N may be connected to a second data line DL2. The first private sub-pixel SPX1_P and the fourth normal sub-pixel SPX4_N may be connected to a third data line DL3. The third private sub-pixel SPX3_P and the fourth private sub-pixel SPX4_P may be connected to a fourth data line DL4.

The first normal sub-pixel SP1_N, the second normal sub-pixel SPX2_N, the fourth normal sub-pixel SPX4_N, and the third private sub-pixel SPX3_P may be connected to a first gate line GL1 transmitting a first gate signal GS1. The first private sub-pixel SPX1_P, the third normal sub-pixel SPX3_N, the second private sub-pixel SPX2_P, and the fourth private sub-pixel SPX4_P may be connected to a second gate line GL2 transmitting a second gate signal GS2.

The test circuit TC may include first to eighth transistors T1 to T8. In an embodiment, the first to eighth transistors T1 to T8 may be PMOS transistors.

The first transistor T1 may include a gate electrode receiving a light-off signal TEST_GATE_OS, a first electrode receiving a first light-off voltage TEST_DATA1, and a second electrode connected to the first data line DL1.

The second transistor T2 may include a gate electrode receiving a red-blue light-on signal TEST_GATE_RB, a first electrode receiving a blue voltage DC_B, and a second electrode connected to the first data line DL1.

The third transistor T3 may include a gate electrode receiving the light-off signal TEST_GATE_OS, a first electrode receiving the first light-off voltage TEST_DATA1, and a second electrode connected to the second data line DL2.

The fourth transistor T4 may include a gate electrode receiving a green light-on signal TEST_GATE_G, a first electrode receiving a green voltage DC_G, and a second electrode connected to the second data line DL2.

The fifth transistor T5 may include a gate electrode receiving the light-off signal TEST_GATE_OS, a first electrode receiving a second light-off voltage TEST_DATA2, and a second electrode connected to the third data line DL3.

The sixth transistor T6 may include a gate electrode receiving the red-blue light-on signal TEST_GATE_RB, a first electrode receiving a red voltage DC_R, and a second electrode connected to the third data line DL3.

The seventh transistor T7 may include a gate electrode receiving the light-off signal TEST_GATE_OS, a first electrode receiving the second light-off voltage TEST_DATA2, and a second electrode connected to the fourth data line DL4.

The eighth transistor T8 may include a gate electrode receiving a private green light-on signal TEST_GATE_G_P, a first electrode receiving the green voltage DC_G, and a second electrode connected to the fourth data line DL4.

Referring to FIG. 10B, the first to fourth normal sub-pixels SPX1_N to SPX4_N and the first to fourth private sub-pixels SPX1_P to SPX4_P may operate in a first duration DU1 and a second duration DU2. The first duration DU1 may include a first sub-duration SD1 and a second sub-duration SD2, and the second duration DU2 may include a third sub-duration SD3 and a fourth sub-duration SD4. In the first sub-duration SD1, each of the first gate signal GS1 and the light-off signal TEST_GATE_OS may have an activation pulse. In the second sub-duration SD2, each of the first gate signal GS1 and the private red light-on signal TEST_GATE_R_P may have the activation pulse. In the third sub-duration SD3, each of the second gate signal GS2 and the light-off signal TEST_GATE_OS may have the activation pulse. In the fourth sub-duration SD4, each of the second gate signal GS2, the private red light-on signal TEST_GATE_R_P, and the red-blue light-on signal TEST_GATE_RB may have the activation pulse.

In the first sub-duration SD1, in response to a first gate signal GS1 having a relatively low level L and a light-off signal TEST_GATE_OS having the relatively low level L, the first normal sub-pixel SPX1_N, the second normal sub-pixel SPX2_N, the fourth normal sub-pixel SPX4_N, and the third private sub-pixel SPX3_P may light off. In the second sub-duration SD2, in response to the first gate signal GS1 having the relatively low level L and a private green light-on signal TEST_GATE_G_P having the relatively low level L, the third private sub-pixel SPX3_P may light on to display the green G. In the third sub-duration SD3, in response to a second gate signal GS2 having the relatively low level L and the light-off signal TEST_GATE_OS having the relatively low level L, the first private sub-pixel SPX1_P, the third normal sub-pixel SPX3_N, the second private sub-pixel SPX2_P, and the fourth private sub-pixel SPX4_P may light off. In the fourth sub-duration SD4, in response to a second gate signal GS2 having the relatively low level L, a private green light-on signal TEST_GATE_G_P having the relatively low level L, and a red-blue light-on signal TEST_GATE_RB having the relatively low level L, the first private sub-pixel SPX1_P may be light on to display the green G, the second private sub-pixel SPX2_P may be light on to display the blue B, and the fourth private sub-pixel SPX4_P may light on to display the green G.

As such, in the display cell 700 in an embodiment of the inventive concept, the test circuit TC may provide a light-on voltage DC_R, DC_B, or DC_G to at least one of the first to fourth private sub-pixels SPX1_P to SPX4_P independently from the first to fourth normal sub-pixels SPX1_N to SPX4_N. Specifically, when the first gate signal GS1 has the relatively low level L, the fourth data line DL4 may transmit the green voltage DC_G. Accordingly, whether the private mode is normally operated may be tested.

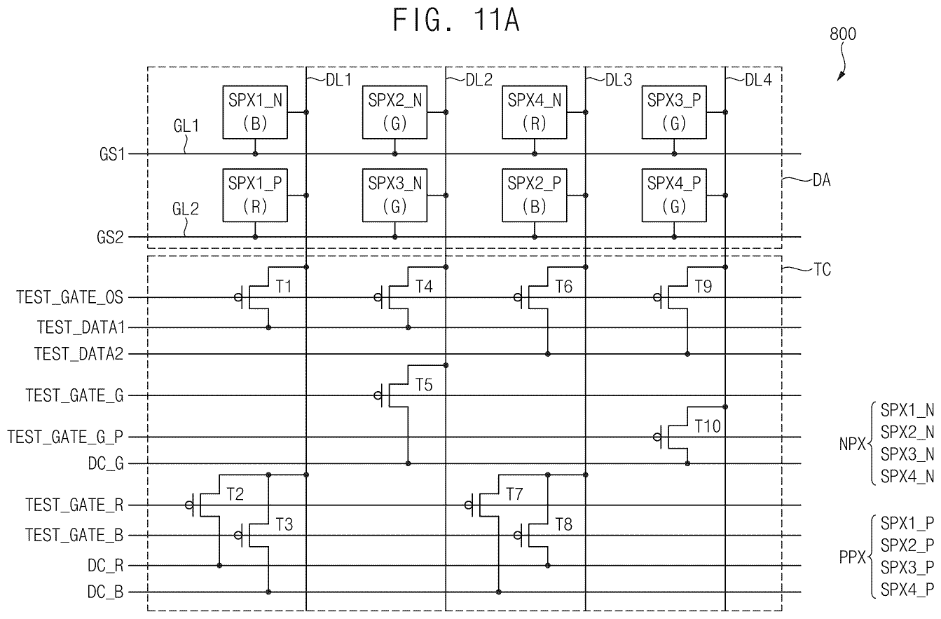

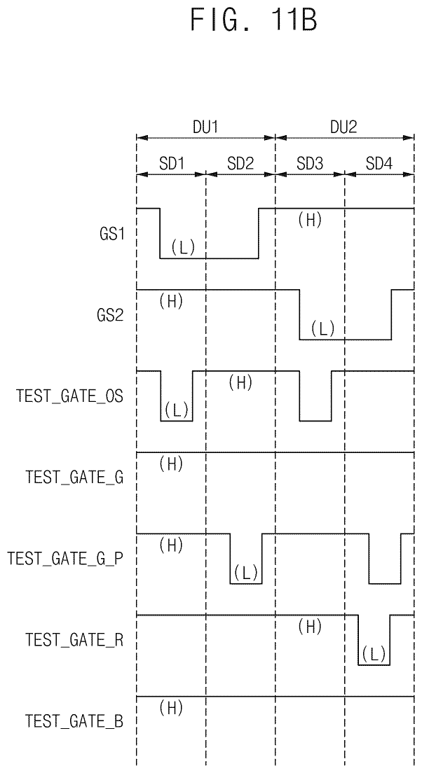

FIG. 11A is a circuit diagram showing an embodiment of a display cell 800 according to the inventive concept. FIG. 11B is a timing diagram showing a signal applied to a display cell 800 in an embodiment of the inventive concept of FIG. 11A.

Referring to FIG. 11A, a display cell 800 in an embodiment of the disclosure may include a display area DA and a test circuit TC.

The display area DA may include a normal pixel NPX and a private pixel PPX. The normal pixel NPX may include first to fourth normal sub-pixels SPX1_N to SPX4_N. The private pixel PPX may include first to fourth private sub-pixels SPX1_P to SPX4_P. In an embodiment, the first normal sub-pixel SPX1_N and the second private sub-pixel SPX2_P may display a blue B. The first private sub-pixel SPX1_P and the fourth normal sub-pixel SPX4_N may display a red R. The second normal sub-pixel SPX2_N, the third normal sub-pixel SPX3_N, the third private sub-pixel SPX3_P, and the fourth private sub-pixel SPX4_P may display a green G.

The first normal sub-pixel SPX1_N and the first private sub-pixel SPX1_P may be connected to a first data line DL1. The second normal sub-pixel SPX2_N and the third normal sub-pixel SPX3_N may be connected to a second data line DL2. The fourth normal sub-pixel SPX4_N and the second private sub-pixel SPX2_P may be connected to a third data line DL3. The third private sub-pixel SPX3_P and the fourth private sub-pixel SPX4_P may be connected to a fourth data line DL4.

The first normal sub-pixel SPX1_N, the second normal sub-pixel SPX2_N, the fourth normal sub-pixel SPX4_N, and the third private sub-pixel SPX3_P may be connected to a first gate line GL1 transmitting a first gate signal GS1. The first private sub-pixel SPX1_P, the third normal sub-pixel SPX3_N, the second private sub-pixel SPX2_P, and the fourth private sub-pixel SPX4_P may be connected to a second gate line GL2 transmitting a second gate signal GS2.

The test circuit TC may include first to tenth transistors T1 to T10. In an embodiment, the first to tenth transistors T1 to T10 may be PMOS transistors.

The first transistor T1 may include a gate electrode receiving a light-off signal TEST_GATE_OS, a first electrode receiving a first light-off voltage TEST_DATA1, and a second electrode connected to the first data line DL1.

The second transistor T2 may include a gate electrode receiving a red light-on signal TEST_GATE_R, a first electrode receiving a red voltage DC_R, and a second electrode connected to the first data line DL1.

The third transistor T3 may include a gate electrode receiving a blue light-on signal TEST_GATE_B, a first electrode receiving a blue voltage DC_B, and a second electrode connected to the first data line DL1.

The fourth transistor T4 may include a gate electrode receiving the light-off signal TEST_GATE_OS, a first electrode receiving the first light-off voltage TEST_DATA1, and a second electrode connected to the second data line DL2.

The fifth transistor T5 may include a gate electrode receiving a green light-on signal TEST_GATE_G, a first electrode receiving a green voltage DC_G, and a second electrode connected to the second data line DL2.

The sixth transistor T6 may include a gate electrode receiving the light-off signal TEST_GATE_OS, a first electrode receiving a second light-off voltage TEST_DATA2, and a second electrode connected to the third data line DL3.

The seventh transistor T7 may include a gate electrode receiving the red light-on signal TEST_GATE_R, a first electrode receiving the blue voltage DC_B, and a second electrode connected to the third data line DL3.

The eighth transistor T8 may include a gate electrode receiving the blue light-on signal TEST_GATE_B, a first electrode receiving the red voltage DC_R, and a second electrode connected to the third data line DL3.

The ninth transistor T9 may include a gate electrode receiving the light-off signal TEST_GATE_OS, a first electrode receiving the second light-off voltage TEST_DATA2, and a second electrode connected to the fourth data line DL4.

The tenth transistor T10 may include a gate electrode receiving a private green light-on signal TEST_GATE_G_P, a first electrode receiving the green voltage DC_G, and a second electrode connected to the fourth data line DL4.

Referring to FIG. 11B, the first to fourth normal sub-pixels SPX1_N to SPX4_N and the first to fourth private sub-pixels SPX1_P to SPX4_P may operate in a first duration DU1 and a second duration DU2. The first duration DU1 may include a first sub-duration SD1 and a second sub-duration SD2, and the second duration DU2 may include a third sub-duration SD3 and a fourth sub-duration SD4. In the first sub-duration SD1, each of the first gate signal GS1 and the light-off signal TEST_GATE_OS may have an activation pulse. In the second sub-duration SD2, each of the first gate signal GS1 and the private green light-on signal TEST_GATE_G_P may have the activation pulse. In the third sub-duration SD3, each of the second gate signal GS2 and the light-off signal TEST_GATE_OS may have the activation pulse. In the fourth sub-duration SD4, each of the second gate signal GS2, the private green light-on signal TEST_GATE_G_P, and the red light-on signal TEST_GATE_R may have the activation pulse.

In the first sub-duration SD1, in response to a first gate signal GS1 having a relatively low level L and a light-off signal TEST_GATE_OS having the relatively low level L, the first normal sub-pixel SPX1_N, the second normal sub-pixel SPX2_N, the fourth normal sub-pixel SPX4_N, and the third private sub-pixel SPX3_P may light off. In the second sub-duration SD2, in response to the first gate signal GS1 having the relatively low level L and a private green light-on signal TEST_GATE_G_P having the relatively low level L, the third private sub-pixel SPX3_P may light on to display the green G. In the third sub-duration SD3, in response to a second gate signal GS2 having the relatively low level L and the light-off signal TEST_GATE_OS having the relatively low level L, the first private sub-pixel SPX1_P, the third normal sub-pixel SPX3_N, the second private sub-pixel SPX2_P, and the fourth private sub-pixel SPX4_P may light off. In the fourth sub-duration SD4, in response to a second gate signal GS2 having the relatively low level L, a private green light-on signal TEST_GATE_G_P having the relatively low level L, and a red light-on signal TEST_GATE_R having the relatively low level L, the first private sub-pixel SPX1_P may light on to display the green G, the second private sub-pixel SPX2_P may light on to display the blue B, and the fourth private sub-pixel SPX4_P may light on to display the green G.

As such, in the display cell 800 in an embodiment of the inventive concept, the test circuit TC may provide a light-on voltage DC_R, DC_B, or DC_G to at least one of the first to fourth private sub-pixels SPX1_P to SPX4_P independently from the first to fourth normal sub-pixels SPX1_N to SPX4_N. Specifically, when the first gate signal GS1 has the relatively low level L, the fourth data line DL4 may transmit the green voltage DC_G. Accordingly, whether the private mode is normally operated may be tested.

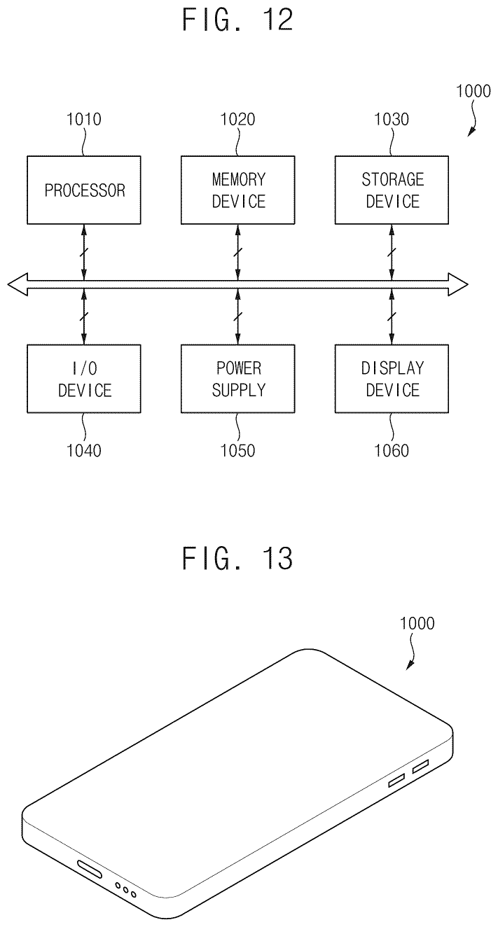

FIG. 12 is a block diagram showing an electronic device 1000. FIG. 13 is a diagram showing an embodiment in which an electronic device 1000 of FIG. 12 is implemented as a smart phone.

Referring to FIGS. 12 and 13, an electronic device 1000 may include a processor 1010, a memory device 1020, a storage device 1030, an input/output (“I/O”) device 1040, a power supply 1050, and a display device 1060. The display device 1060 may be the display device 10 of FIG. 1. In addition, the electronic device 1000 may further include a plurality of ports for communicating with a video card, a sound card, a memory card, a universal serial bus (“USB”) device, other electronic device, or the like.

In an embodiment, as illustrated in FIG. 13, the electronic device 1000 may be implemented as the smart phone. However, the electronic device 1000 is not limited thereto. In an embodiment, the electronic device 1000 may be implemented as a cellular phone, a video phone, a smart pad, a smart watch, a tablet personal computer (“PC”), a car navigation system, a computer monitor, a laptop, a head mounted display (“HMD”) device, or the like, for example.

The processor 1010 may perform various computing functions. The processor 1010 may be a micro processor, a central processing unit (“CPU”), an application processor (“AP”), or the like. The processor 1010 may be coupled to other components via an address bus, a control bus, a data bus, or the like. Further, the processor 1010 may be coupled to an extended bus such as a peripheral component interconnection (“PCI”) bus.

The memory device 1020 may store data for operations of the electronic device 1000. In an embodiment, the memory device 1020 may include at least one nonvolatile memory device such as an erasable programmable read-only memory (“EPROM”) device, an electrically erasable programmable read-only memory (“EEPROM”) device, a flash memory device, a phase change random access memory (“PRAM”) device, a resistance random access memory (“RRAM”) device, a nano floating gate memory (“NFGM”) device, a polymer random access memory (“PoRAM”) device, a magnetic random access memory (“MRAM”) device, a ferroelectric random access memory (“FRAM”) device, or the like and/or at least one volatile memory device such as a dynamic random access memory (“DRAM”) device, a static random access memory (“SRAM”) device, a mobile DRAM device, or the like, for example.

The storage device 1030 may include a solid state drive (“SSD”) device, a hard disk drive (“HDD”) device, a compact disc read-only memory (“CD-ROM”) device, or the like.

The I/O device 1040 may include an input device such as a keyboard, a keypad, a mouse device, a touch-pad, a touch-screen, or the like, and an output device such as a printer, a speaker, or the like. In some embodiments, the I/O device 1040 may include the display device 1060.

The power supply 1050 may provide power for operations of the electronic device 1000.

The display device 1060 may be connected to other components through buses or other communication links.

The inventive concepts may be applied to any display device and any electronic device including the touch panel. In an embodiment, the inventive concepts may be applied to a mobile phone, a smart phone, a tablet computer, a digital television (“TV”), a three dimensional (“3D”) TV, a personal computer PC, a home appliance, a laptop computer, a personal digital assistant (“PDA”), a portable multimedia player (“PMP”), a digital camera, a music player, a portable game console, a navigation device, etc., for example.

The foregoing is illustrative of the inventive concept and is not to be construed as limiting thereof. Although a few embodiments of the inventive concept have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims. In the claims, means-plus-function clauses are intended to cover the structures described herein as performing the recited function and not only structural equivalents but also equivalent structures. Therefore, it is to be understood that the foregoing is illustrative of the inventive concept and is not to be construed as limited to the illustrative embodiments disclosed, and that modifications to the disclosed embodiments, as well as other embodiments, are intended to be included within the scope of the appended claims. The inventive concept is defined by the following claims, with equivalents of the claims to be included therein.

What is claimed is:

1. A display cell, comprising:
a display area including:
a normal pixel which includes a first normal sub-pixel to a fourth normal sub-pixel and has a normal viewing angle; and
a private pixel which includes a first private sub-pixel to a fourth private sub-pixel and has a private viewing angle different from the normal viewing angle; and
a test circuit configured to test a private mode in which only the private pixel is illuminated by providing a light-off voltage and a light-on voltage to the normal pixel and the private pixel,
wherein the test circuit provides the light-on voltage to at least one of the first private sub-pixel to the fourth private sub-pixel independently from the first normal sub-pixel to the fourth normal sub-pixel.

2. The display cell of claim 1, wherein the private viewing angle is less than the normal viewing angle.

3. The display cell of claim 1, wherein the first normal sub-pixel and the second normal sub-pixel are connected to a first data line, the third normal sub-pixel and the first private sub-pixel are connected to a second data line, the second private sub-pixel and the third private sub-pixel are connected to a third data line, and the fourth normal sub-pixel and the fourth private sub-pixel are connected to a fourth data line.

4. The display cell of claim 3, wherein the first normal sub-pixel and the third private sub-pixel display a blue,
the second normal sub-pixel and the second private sub-pixel display a red, and
the third normal sub-pixel, the first private sub-pixel, the fourth normal sub-pixel, and the fourth private sub-pixel display a green.

5. The display cell of claim 3, wherein the first normal sub-pixel, the third normal sub-pixel, the second private sub-pixel, and the fourth normal sub-pixel receive the light-off voltage and the light-on voltage in response to a first gate signal, and
the second normal sub-pixel, the first private sub-pixel, the third private sub-pixel, and the fourth private sub-pixel receive the light-off voltage and the light-on voltage in response to a second gate signal.

6. The display cell of claim 5, wherein the test circuit comprises:
a first transistor including a gate electrode which receives a light-off signal, a first electrode which receives a first light-off voltage, and a second electrode connected to the first data line;
a second transistor including a gate electrode which receives a red light-on signal, a first electrode which receives a red voltage, and a second electrode connected to the first data line;
a third transistor including a gate electrode which receives a blue light-on signal, a first electrode which receives a blue voltage, and a second electrode connected to the first data line;
a fourth transistor including a gate electrode which receives the light-off signal, a first electrode which receives the first light-off voltage, and a second electrode connected to the second data line;
a fifth transistor including a gate electrode which receives a green light-on signal, a first electrode which receives a green voltage, and a second electrode connected to the second data line;
a sixth transistor including a gate electrode which receives the light-off signal, a first electrode which receives a second light-off voltage, and a second electrode connected to the third data line;
a seventh transistor including a gate electrode which receives a private red light-on signal, a first electrode which receives the red voltage, and a second electrode connected to the third data line;
an eighth transistor including a gate electrode which receives a private blue light-on signal, a first electrode which receives the blue voltage, and a second electrode connected to the third data line;
a ninth transistor including a gate electrode which receives the light-off signal, a first electrode which receives the second light-off voltage, and a second electrode connected to the fourth data line; and
a tenth transistor including a gate electrode which receives the green light-on signal, a first electrode which receives the green voltage, and a second electrode connected to the fourth data line.

7. The display cell of claim 6, wherein, in a first sub-duration, each of the first gate signal and the light-off signal has an activation pulse,
in a second sub-duration, each of the first gate signal and the private red light-on signal has the activation pulse,
in a third sub-duration, each of the second gate signal and the light-off signal has the activation pulse, and
in a fourth sub-interval, each of the second gate signal, the private blue light-on signal, and the green light-on signal has the activation pulse.

8. The display cell of claim 5, wherein the test circuit comprises:
a first transistor including a gate electrode which receives a private red light-on signal, a first electrode which receives a first light-off voltage, and a second electrode connected to the first data line;
a second transistor including a gate electrode which receives a private blue light-on signal, a first electrode which receives the first light-off voltage, and a second electrode connected to the first data line;
a third transistor including a gate electrode which receives a red light-on signal, a first electrode which receives a red voltage, and a second electrode connected to the first data line;
a fourth transistor including a gate electrode which receives a blue light-on signal, a first electrode which receives a blue voltage, and a second electrode connected to the first data line;
a fifth transistor including a gate electrode which receives the private red light-on signal, a first electrode which receives the first light-off voltage, and a second electrode connected to the second data line;
a sixth transistor including a gate electrode which receives a green light-on signal, a first electrode which receives a green voltage, and a second electrode connected to the second data line;
a seventh transistor including a gate electrode which receives the private red light-on signal, a first electrode which receives the red voltage, and a second electrode connected to the third data line;
an eighth transistor including a gate electrode which receives the private blue light-on signal, a first electrode which receives the blue voltage, and a second electrode connected to the third data line;
a ninth transistor including a gate electrode which receives the red light-on signal, a first electrode which receives the blue voltage, and a second electrode connected to the third data line;
a tenth transistor including a gate electrode which receives the blue light-on signal, a first electrode which receives the red voltage, and a second electrode connected to the third data line;
an eleventh transistor including a gate electrode which receives the private red light-on signal, a first electrode which receives the first light-off voltage, and a second electrode connected to the fourth data line; and
a twelfth transistor including a gate electrode which receives the green light-on signal, a first electrode which receives the green voltage, and a second electrode connected to the fourth data line.

9. The display cell of claim 8, wherein, in a first sub-duration, the first gate signal has an activation pulse,
in a second sub-duration, each of the first gate signal and the private red light-on signal has the activation pulse,
in a third sub-duration, the second gate signal has the activation pulse, and
in a fourth sub-duration, each of the second gate signal, the private blue light-on signal, and the green light-on signal has the activation pulse.

10. The display cell of claim 1, wherein the first normal sub-pixel and the second normal sub-pixel are connected to a first data line, the third normal sub-pixel and the fourth normal sub-pixel are connected to a second data line, the second private sub-pixel and the third private sub-pixel are connected to a third data line, and the first private sub-pixel and the fourth private sub-pixel are connected to a fourth data line.

11. The display cell of claim 10, wherein the first normal sub-pixel and the third private sub-pixel display a blue,
the second normal sub-pixel and the second private sub-pixel display a red, and
the third normal sub-pixel, the first private sub-pixel, the fourth normal sub-pixel, and the fourth private sub-pixel display a green.

12. The display cell of claim 10, wherein the first normal sub-pixel, the third normal sub-pixel, the second private sub-pixel, and the fourth normal sub-pixel receive the light-off voltage and the light-on voltage in response to a first gate signal, and
wherein the second normal sub-pixel, the first private sub-pixel, the third private sub-pixel, and the fourth private sub-pixel receive the light-off voltage and the light-on voltage in response to a second gate signal.

13. The display cell of claim 12, wherein the test circuit comprises:
a first transistor including a gate electrode which receives a light-off signal, a first electrode which receives a first light-off voltage, and a second electrode connected to the first data line;
a second transistor including a gate electrode which receives a red light-on signal, a first electrode which receives a red voltage, and a second electrode connected to the first data line;
a third transistor including a gate electrode which receives a blue light-on signal, a first electrode which receives a blue voltage, and a second electrode connected to the first data line;
a fourth transistor including a gate electrode which receives the light-off signal, a first electrode which receives the first light-off voltage, and a second electrode connected to the second data line;
a fifth transistor including a gate electrode which receives a green light-on signal, a first electrode which receives a green voltage, and a second electrode connected to the second data line;
a sixth transistor including a gate electrode which receives the light-off signal, a first electrode which receives a second light-off voltage, and a second electrode connected to the third data line;
a seventh transistor including a gate electrode which receives a private red light-on signal, a first electrode which receives the red voltage, and a second electrode connected to the third data line;
an eighth transistor including a gate electrode which receives a private blue light-on signal, a first electrode which receives the blue voltage, and a second electrode connected to the third data line;
a ninth transistor including a gate electrode which receives the light-off signal, a first electrode which receives the second light-off voltage, and a second electrode connected to the fourth data line; and
a tenth transistor including a gate electrode which receives a private green light-on signal, a first electrode which receives the green voltage, and a second electrode connected to the fourth data line.

14. The display cell of claim 13, wherein, in a first sub-duration, each of the first gate signal and the light-off signal has an activation pulse,
in a second sub-duration, each of the first gate signal and the private red light-on signal has the activation pulse,
in a third sub-duration, each of the second gate signal and the light-off signal has the activation pulse, and
in a fourth sub-duration, each of the second gate signal and the private blue light-on signal has the activation pulse.

15. The display cell of claim 1, wherein the first normal sub-pixel and the third private sub-pixel are connected to a first data line, the third normal sub-pixel and the first private sub-pixel are connected to a second data line, the second normal sub-pixel and the second private sub-pixel are connected to a third data line, and the fourth normal sub-pixel and the fourth private sub-pixel are connected to a fourth data line.

16. The display cell of claim 15, wherein the first normal sub-pixel and the third private sub-pixel display a blue,
the second normal sub-pixel and the second private sub-pixel display a red, and
the third normal sub-pixel, the first private sub-pixel, the fourth normal sub-pixel, and the fourth private sub-pixel display a green.

17. The display cell of claim 15, wherein the first normal sub-pixel, the third normal sub-pixel, the second private sub-pixel, and the fourth normal sub-pixel receive the light-off voltage and the light-on voltage in response to a first gate signal, and
wherein the second normal sub-pixel, the first private sub-pixel, the third private sub-pixel, and the fourth private sub-pixel receive the light-off voltage and the light-on voltage in response to a second gate signal.

18. The display cell of claim 17, wherein the test circuit comprises:
a first transistor including a gate electrode which receives a light-off signal, a first electrode which receives a first light-off voltage, and a second electrode connected to the first data line;
a second transistor including a gate electrode which receives a green-blue light-on signal, a first electrode which receives a blue voltage, and a second electrode connected to the first data line;
a third transistor including a gate electrode which receives the light-off signal, a first electrode which receives the first light-off voltage, and a second electrode connected to the second data line;
a fourth transistor including a gate electrode which receives the green-blue light-on signal, a first electrode which receives a green voltage, and a second electrode connected to the second data line;
a fifth transistor including a gate electrode which receives the light-off signal, a first electrode which receives a second light-off voltage, and a second electrode connected to the third data line;
a sixth transistor including a gate electrode which receives a red light-on signal, a first electrode which receives a red voltage, and a second electrode connected to the third data line;
a seventh transistor including a gate electrode which receives the light-off signal, a first electrode which receives the second light-off voltage, and a second electrode connected to the fourth data line; and
an eighth transistor including a gate electrode which receives the green-blue light-on signal, a first electrode which receives the green voltage, and a second electrode connected to the fourth data line.

19. The display cell of claim 18, wherein in a first sub-duration, each of the first gate signal and the light-off signal has an activation pulse,
in a second sub-duration, each of the first gate signal and the red light-on signal has the activation pulse,
in a third sub-duration, each of the second gate signal and the light-off signal has the activation pulse, and
in a fourth sub-duration, each of the second gate signal and the green-blue light-on signals has the activation pulse.

20. A test system, comprising:
a display cell including a display area and a test circuit connected to the display area; and
a test device configured to provide a signal and a voltage to the display cell,
wherein the display area including a normal pixel which includes a first normal sub-pixel to a fourth normal sub-pixel and has a normal viewing angle, and a private pixel which includes a first private sub-pixel to a fourth private sub-pixel and has a private viewing angle different from the normal viewing angle,
wherein a test circuit tests a private mode in which only the private pixel is illuminated by providing a light-off voltage and a light-on voltage to the normal pixel and the private pixel, and
wherein the test circuit provides the light-on voltage to at least one of the first private sub-pixel to the fourth private sub-pixel independently from the first normal sub-pixel to the fourth normal sub-pixel.
